(19) United States
(12) Patent Application Publication
(10) Pub. No.: US 2025/0326323 A1
(43) Pub. Date: Oct. 23, 2025

(54) Apparatus, Systems, and Methods for Predictive Electrical Load Management of Electric Vehicle Chargers

(71) Applicant: WEEV ENERGY B.F. LTD, Herzeliya (IL)

(72) Inventors: Adi Baron, Ganei Tikva (IL); Ariela Blumer, Tel Aviv (IL)

(21) Appl. No.: 19/252,388

(22) Filed: Jun. 27, 2025

Related U.S. Application Data
(63) Continuation-in-part of application No. PCT/IB24/53807, filed on Apr. 18, 2024.
(63) Continuation-in-part of application No. PCT/IB23/60074, filed on Oct. 6, 2023.
(63) Continuation-in-part of application No. PCT/IB23/58581, filed on Aug. 30, 2023.
(63) Continuation-in-part of application No. PCT/IB23/58584, filed on Aug. 30, 2023.
(63) Continuation-in-part of application No. PCT/IB23/58582, filed on Aug. 30, 2023.
(60) Provisional application No. 63/477,676, filed on Dec. 29, 2022.
(60) Provisional application No. 63/477,676, filed on Dec. 29, 2022.
(60) Provisional application No. 63/478,229, filed on Jan. 3, 2023.
(60) Provisional application No. 63/482,706, filed on Feb. 1, 2023.
(60) Provisional application No. 63/488,661, filed on Mar. 6, 2023.
(60) Provisional application No. 63/497,011, filed on Apr. 19, 2023.

(51) Int. Cl. B60L 53/68; B60L 53/62; B60L 53/64; B60L 53/67; G05B 13/02

(52) U.S. Cl. CPC B60L 53/68; B60L 53/62; B60L 53/64; B60L 53/67; G05B 13/0265

(57) ABSTRACT

Apparatus, systems, and methods for charging electric vehicles (EVs) at an EV charging site having a plurality of EV chargers, controlling by a management server the charging performed by a plurality of EV chargers at a charging site when connectivity quality between the management server and any of the EV chargers may be unstable, and electrical load reserve for use by an EV charging system of a site.

### CROSS-REFERENCE TO RELATED APPLICATIONS

This application is a continuation-in-part of: (i) PCT application PCT/IB23/58581, filed on Aug. 30, 2023, which claims priority to U.S. Provisional Application No. 63/477,676 filed on Dec. 29, 2022; (ii) PCT application PCT/IB23/58582, filed on Aug. 30, 2023, which claims priority to U.S. Provisional Application No. 63/477,676, filed on Dec. 29, 2022, and U.S. Provisional Application No. 63/478,229 filed on Jan. 3, 2023; (iii) PCT application PCT/IB23/58584, filed Aug. 30, 2023, which claims priority to U.S. Provisional Application No. 63/482,706 filed on Feb. 1, 2023; (iv) PCT application PCT/IB23/60074, filed Oct. 6, 2023, which claims priority to U.S. Provisional Application No. 63/488,661 filed on Mar. 6, 2023; and (v) PCT application PCT/IB24/53807, filed Apr. 18, 2024, which claims priority to U.S. Provisional Application No. 63/497,011 filed on Apr. 19, 2023. Each of the above-mentioned applications is incorporated herein by reference in its entirety.

### TECHNICAL FIELD

The disclosure generally relates to electric vehicles, (EVs), and more particularly to apparatus, systems and methods for predicting and managing electrical load of EV chargers, managing electrical load between EV chargers, and maintaining an electrical load reserve for an (EV) charging system.

### BACKGROUND

Over the last few years more and more people have started using electric vehicles. EV chargers are used for charging the batteries of the EVs and are usually installed in private houses, apartment buildings, shopping centers, charging centers and workplaces.

Installation and management of EV chargers on a large scale in apartment buildings, shopping centers and workplaces is extremely complicated due to power constraints, complex billing, and infrastructure updates that are typically required.

Any EV charging site has an electrical infrastructure which is always only able to provide a limited amount of electric power at the site. When too many EVs connect to the EV chargers at a single site and try to start charging at the same time, the outcome is usually a relatively low charging rate for all of the EVs at the site. When electrical devices, other than the EV chargers, create non-EV load, while simultaneously too many EV chargers create EV-load, a power outage may occur at the site. Therefore, it would be advantageous to provide a solution that overcomes the shortcomings of prior art solutions noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for charging a plurality of electric vehicles (EV) at an EV charging site. The method comprises: collecting, by a management server, a first dataset that is indicative of electric vehicle charging properties of each EV user of a plurality of EV users, wherein each EV user is associated with at least one EV of the plurality of EVs; collecting, by the management server, a second dataset that is indicative of electrical properties of the EV charging site, wherein the EV charging site comprises a plurality of EV chargers connected to an electric infrastructure of the EV charging site, wherein each of the plurality of EV chargers is configured to charge a respective EV of the plurality of EVs; collecting, by the management server, a third dataset that is indicative of electricity prices in a region in which the EV charging site is located; determining, by the management server, a real-time state of each EV charger of the plurality of EV chargers; generating an EV charging plan for the EV charging site based on the first dataset, the second dataset, the third dataset and the real-time state of each EV charger of the plurality of EV chargers; and developing, by the management server, a schedule for charging operation of each of the EV chargers of the plurality of EV chargers in the EV charging site based on the EV charging plan; causing, by the management server, each of the EV chargers to operate for charging according to the schedule; wherein the first dataset, the second dataset, the third dataset and the state of each EV charger are continuously monitored by the management server in real time; and wherein the charging plan and schedule for charging are updated in real-time based on any changes detected by the management server in the first dataset, the second dataset, the third dataset and the state of each of the EV chargers.

Certain embodiments disclosed herein also include a system for charging a plurality of electric vehicles (EV) at an EV charging site. The system comprises a processing circuitry; and a memory, the memory containing instructions that, when executed by the processing circuitry, configure the system to: collect a first dataset that is indicative of electric vehicle charging properties of each EV user of a plurality of EV users, wherein each EV user is associated with at least one EV of the plurality of EVs; collect a second dataset that is indicative of electrical properties of the EV charging site, wherein the EV charging site comprises a plurality of EV chargers connected to an electric infrastructure of the EV charging site, wherein each of the plurality of EV chargers is configured to charge a respective EV of the plurality of EVs, wherein each of the plurality of EV chargers is configured to charge the at least one EV; collect a third dataset that is indicative of electricity prices in a region in which the EV charging site is located; determine a real-time state of each EV charger of the plurality of EV chargers; generate an EV charging plan for the EV charging site based on the first dataset, the second dataset, the third dataset and the real-time state of each EV charger of the plurality of EV chargers; and develop a schedule for charging operation of each of the EV chargers of the plurality of EV chargers in the EV charging site based on the EV charging plan; wherein the first dataset, the second dataset, the third dataset and the state of each EV charger are continuously monitored by the system in real time; and wherein the charging plan and schedule for charging are updated in real-time based on any changes detected by the system in the first dataset, the second dataset, the third dataset and the state of each of the EV chargers.

Certain embodiments disclosed herein include a method for management by a management server of electrical load of a plurality of electric vehicles (EV) chargers when connectivity quality between the management server and any of the EV chargers may be unstable.

Certain embodiments disclosed herein include a method for management by a management server of electrical load of a plurality of electric vehicles (EV) chargers when connectivity quality between the management server and any of the EV chargers may be unstable. The method comprises: applying, by the management server, an EV baseline charging policy to a plurality of EV chargers that are located in a charging site, wherein the EV baseline charging policy is applied for a first predetermined period; monitoring, by the management server, the connectivity quality between the management server and each of the plurality of EV chargers; overriding, by the management server, the EV baseline charging policy applied to at least one EV charger of the plurality of EV chargers by a first EV active charging policy upon determination that (a) all conditions to start charging are met and (b) a connectivity quality between the at least one EV charger and the management server is above a predetermined threshold, wherein the first EV active charging policy is applied for a second predetermined period; and, applying, by the management server, a second EV active charging policy to the at least one EV charger upon determination that (a) the first EV active charging policy was revoked, (b) connectivity quality between the at least one EV charger and the management server is above the predetermined threshold, and (c) charging has not yet been completed, wherein the second EV active charging policy is applied for a third predetermined period.

Certain embodiments disclosed herein also include a system for management of electrical load of a plurality of electric vehicles (EV) chargers when connectivity quality may be unstable. The system comprises a processing circuitry; and a memory, the memory containing instructions that, when executed by the processing circuitry, configure the system to: apply an EV baseline charging policy to a plurality of EV chargers that are located in a charging site, wherein the EV baseline charging policy is applied for a first predetermined period; monitor the connectivity quality between the management server and each of the plurality of EV chargers; override the EV baseline charging policy applied to at least one EV charger of the plurality of EV chargers by a first EV active charging policy upon determination that (a) all conditions to start charging are met and (b) a connectivity quality between the at least one EV charger and the management server is above a predetermined threshold, wherein the first EV active charging policy is applied for a second predetermined period; and apply a second EV active charging policy to the at least one EV charger upon determination that (a) the first EV active charging policy was revoked, (b) connectivity quality between the at least one EV charger and the management server is above the predetermined threshold, and (c) charging has not yet been completed, wherein the second EV active charging policy is applied for a third predetermined period.

Certain embodiments disclosed herein include a method for controlling by a management server charging performed by a plurality of electric vehicle (EV) chargers at a charging site when connectivity quality between the management server and any of the EV chargers may be unstable, wherein, when a connectivity quality of a connection between a charger of the plurality and a management server is below a threshold, a baseline charging policy is applied by the management server for such charger, the method comprising: for each one of the chargers of the plurality of chargers having the connectivity quality of its connection with the management server above the threshold, applying an active charging policy thereto by the management server; wherein each active charging policy allows the one of the chargers to which it is applied to supply more amperage than is permitted according to the baseline charging policy.

Certain embodiments disclosed herein include a method for maintaining an electrical load reserve for use by an electrical vehicle (EV) charging system of a site. The method comprises: obtaining, by a management server, a value of maximum electrical current supply that can be provided to the site; collecting, by the management server, over a first period, time series data of electrical current consumption of a non-EV load of the site; determining, by the management server, for each of a plurality of non-overlapping second periods, an electrical current consumption value for the non-EV load that provides a margin above the maximum electrical current consumption of the non-EV load of each of the second periods; and controlling in real-time, by the management server, a supply of electrical current to the EV charging system of the site during a third period so that the EV charging system receives electrical current that does not exceed the difference between the maximum electrical current supply value and the electrical current consumption value for the non-EV load that provides a margin above the maximum electrical current consumption of the non-EV load of the second period of the plurality of non-overlapping second periods that is similar to the third period based on at least a comparison of a length of time.

Certain embodiments disclosed herein include a system for maintaining an electrical load reserve for use by an electrical vehicle (EV) charging system of a site. The system comprises: a processing circuitry; and a memory, the memory containing instructions that, when executed by the processing circuitry, configure the system to: obtain a value of maximum electrical current supply that can be provided to the site; collect, by the management server, over a first period, time series data of electrical current consumption of a non-EV load of the site; determine for each of a plurality of non-overlapping second periods, an electrical current consumption value for the non-EV load that provides a margin above the maximum electrical current consumption of the non-EV load of each of the second periods; and control in real-time supply of electrical current to the EV charging system of the site during a third period so that the EV charging system receives electrical current that does not exceed the difference between the maximum electrical current supply value and the electrical current consumption value for the non-EV load that provides a margin above the maximum electrical current consumption of the non-EV load of the second period of the plurality of non-overlapping second periods that is similar to the third period based on at least a comparison of a length of time.

### BRIEF DESCRIPTION OF THE DRAWING

In the drawing:

FIG. 1 shows an illustrative network diagram for use in implementing an embodiment of the disclosure;

FIG. 2 shows an illustrative embodiment of a management server;

FIG. 3 shows a flowchart of an illustrative process for performing predictive electrical load management for a plurality of EV chargers, according to an embodiment;

FIG. 4A shows an illustrative optimal EV charging plan for a plurality of EV chargers of an EV charging site, according to an embodiment;

FIG. 4B is a diagram showing an example of collected data for a plurality of EV chargers of an EV charging site, according to an embodiment;

FIG. 4C shows an illustrative traditional, i.e., prior art, EV charging plan for a plurality of EV chargers;

FIG. 5 shows an illustrative network diagram for use in implementing an embodiment of the disclosure;

FIG. 6 shows an illustrative embodiment of a management server;

FIG. 7 shows a flowchart of an illustrative process for managing electrical load of a plurality of electric vehicles (EV) chargers when connectivity is unstable, according to an embodiment;

FIG. 8 shows a flowchart for an illustrative method for associating EV charging policies with EV chargers of a charging site, according to an embodiment;

FIG. 9 shows an illustrative diagram demonstrating an example of the management of electrical load of a plurality of electric vehicles (EV) chargers when connectivity is unstable, according to an embodiment.

FIG. 10 is a diagram of an illustrative network system utilized to discuss the disclosed embodiments;

FIG. 11 is an illustrative block diagram of a management server, according to an embodiment;

FIG. 12 is an illustrative diagram demonstrating the maintenance of electrical load reserve for management of electricity supply to an electrical vehicle (EV) charging system, according to an embodiment; and

FIG. 13 is a flowchart of an illustrative method for generating customized electric vehicles (EV) charging plans for EV users of an EV charging site, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to examples, the disclosed system and methods are utilized for efficiently managing the electrical load of electric vehicles at a charging site by learning the EV users' charging patterns. To that end, data that is indicative of EV users' charging properties, the charging site's electrical properties, and electricity prices, is collected. When conditions to start charging one or more EV chargers are met, the system generates an optimal EV charging plan enabling an efficient charging of the EVs connected to the EV chargers of the site. The optimal EV charging plan is generated based on the data collected with respect to the EV user's properties, EV charging site electrical properties, and the electricity prices associated with the region in which the site is located. Then, the system schedules the operation of each active EV charger based on the optimal EV charging plan.

According to examples, baseline charging policy is applied by a management server, for a first period, to a plurality of EV chargers that are located in a charging site. The connectivity quality between a management server and each of the EV chargers is monitored. The system overrides the baseline charging policy applied to an EV charger and applies, for a second period, a first active charging policy instead of the baseline charging policy, upon determination that (a) all conditions to start charging the EV charger have been met and (b) a connectivity quality between the EV charger and the management server is above a predetermined threshold. The management server generates and applies a second active charging policy to the EV charger upon determination that (a) the first EV active charging policy was revoked, (b) the connectivity quality between the EV charger and the management server is above the predetermined threshold, and (c) charging has not yet been completed.

According to examples, the disclosed method is used for maintaining an electrical load reserve for management of electricity supply to electrical vehicle (EV) charging system. A maximum electrical current supply value that can be provided to a site is obtained. Time series data of electrical current consumption of a non-EV load of the site is collected over a first period, e.g., a day, a week, a month, a quarter, etc. Then, an electrical current consumption value that provides a margin above the maximum electrical current consumption of each second period of a plurality of non-overlapping second periods that collectively make up the first period is determined for each of the plurality of non-overlapping second periods. The EV charging system is then controlled during each particular third period of a plurality of nonoverlapping third periods to receive electrical current that does not exceed the difference between the maximum electrical current supply value and the electrical current consumption value of a one of the plurality of non-overlapping second periods that is similar to the particular third period for which the current is being supplied.

It is noted that the teachings of the presently disclosed subject matter are not bound by the systems and apparatuses described with reference to the figures. Equivalent and/or modified functionality may be consolidated or divided in another manner and may be implemented in any appropriate combination. For example, elements which are shown as separate units, may have their functionalities and/or components combined into a single unit.

It is also noted that like references in the various figures may refer to like elements throughout the application. Similar reference numbers may also connote similarities between elements. Throughout the application certain general references may be used to refer to any of the specific related elements. For example, management server 120 may refer to management server 120A, management server 120B, and/or management server 120C.

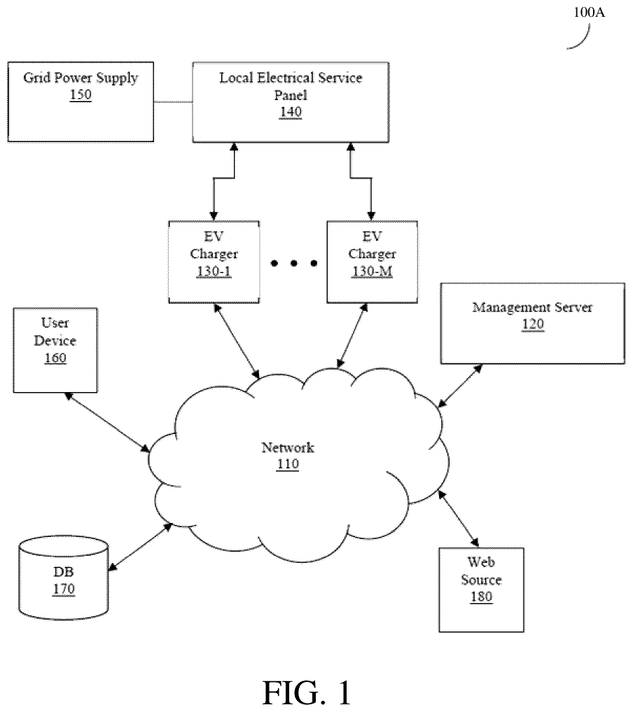

FIG. 1 shows an illustrative network diagram 100A for use in implementing an embodiment of the disclosure. FIG. 1 shows a management server 120 and a plurality of electric vehicle chargers 130-1 through 130-M, where M is an integer equal to or greater than 1, hereinafter referred to as EV charger 130 or EV chargers 130, merely for simplicity, one or more user devices 160, a database (DB) 170, and one or more web sources 180 which are all communicatively coupled by a network 110. The network 110 may be a wireless network, a wired network, a wide area network (WAN), a local area network (LAN), or any other kind of applicable network, as well as any combination thereof.

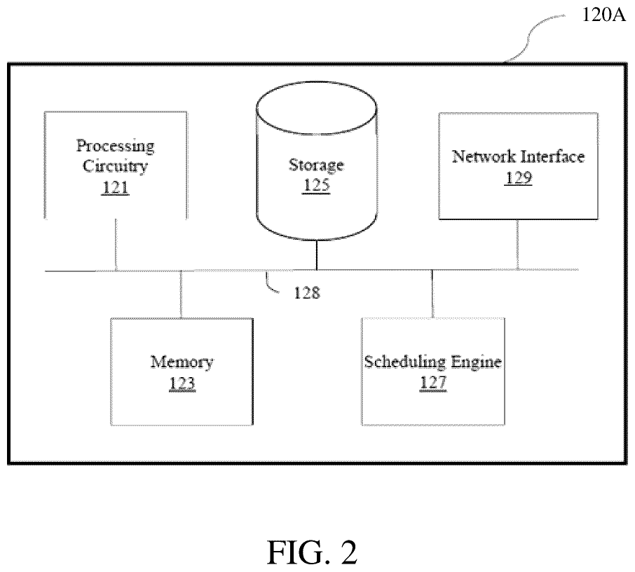

The management server 120 may include hardware and software which enable the management server 120 to collect datasets, analyze data, receive information from the EV chargers, e.g., the EV chargers 130, send instructions to the EV chargers, and the like. The components of the management server 120 are further described with respect to FIG. 2. In an embodiment, the management server 120 is deployed in a cloud computing platform, such as Amazon® AWS or Microsoft® Azure.

The EV charger 130 is a piece of equipment that supplies electrical power for charging plug-in EVs. An EV charger is usually connected to a local electrical service panel, e.g., the local electrical service panel 140, while the local electrical service panel is connected to a grid power supply, e.g., the grid power supply 150, from which the electric power is provided to the EV charger 130. The local electrical service panel 140 is a central distribution point that connects the external wires coming from the grid and the internal electrical wires of the electrical system of the EV charging site. The grid power supply 150 is an interconnected network for electricity delivery from electricity producers to electricity consumers.

The EV chargers 130 may further include a network interface (not shown) by which the EV chargers 130 are able to communicate with, for example, the management server 120. EV chargers are usually located in shopping centers, government facilities, as well as at residences, workplaces, and hotels. In many cases there are multiple EV chargers that operate at the same time at such EV charging sites and therefore an efficient allocation of the electric power among the active EV chargers is required to enable an efficient charging of the EV that are connected to the EV chargers.

The user device 160 may be for example a smartphone, a tablet, a smart wearable device, and the like. The user device 160 may include an application (not shown) allowing it to collect data about the EV user's EV charging habit and to communicate with the management server 120, the EV charger 130, other user devices of other users, and the like.

The database 170 is a data warehouse that is configured to store, for example, data regarding the EV user, the EV of the user, charging properties of users, users' profiles, data regarding the charging site, e.g., electrical load capacity of the charging site, electricity prices, and so on. The database 170 may be a centralized database, a cloud database, and the like.

The web source, or web sources 180 may include a server, a website, a government website, a database, and the like. For example, the web source 180 may be a website of an official authority in which electricity prices are shown and updated from time to time.

FIG. 2 is an example schematic diagram of a management server 120A according to an embodiment. The management server 120A includes a processing circuitry 121 coupled to a memory 123, a storage 125, a scheduling engine 127 and a network interface 129. The components of the management server 120A may be communicatively connected via a bus 128.

The processing circuitry 121 may be realized as one or more hardware logic components and circuits. For example, and without limitation, illustrative types of hardware logic components that can be used, include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 123 may be volatile, e.g., RAM, etc., non-volatile, e.g., ROM, flash memory, etc., or a combination thereof. In one configuration, computer readable instructions to implement one or more embodiments disclosed herein may be stored in the storage 125.

In another embodiment, the memory 123 is configured to store software. Software shall be construed broadly to mean any type of instructions, whether referred to as software, firmware, middleware, microcode, or hardware description language. Instructions may include code in formats such as source code, binary code, executable code, or any other suitable format of code. The instructions, when executed by the one or more processing circuitry 121, cause the processing circuitry 121 to perform the various processes described herein.

The storage 125 may be magnetic storage, optical storage, and the like, and may be realized, for example, as flash memory or other memory technology, or any other medium which can be used to store the desired information.

The scheduling engine 127 may include hardware and software which enable the scheduling engine 127 to collect and analyze data, generate outputs, and the like. The scheduling engine 127 manages at least the creation and cancellation of EV charging plans of an EV charging site. The scheduling engine 127 may be configured to receive data associated with, for example, EV charging properties of users, electrical capacity of the EV charging site, electricity prices, activated EV chargers, etc., and determine an optimal EV charging plan which considers all the active EV chargers in the EV charging site. To that end, the scheduling engine 127 may use a set of rules which may be stored in a memory, e.g., the memory 123, machine learning (ML) techniques, and so on.

The network interface 129 is configured to connect to a network, e.g., the network 110. The network interface 129 allows the management server 120 to communicate with at least the user devices 160, the EV chargers, the DB 170, and the like. The network interface 129 may include a wired port or a wireless port, e.g., an 802.11 compliant Wi-Fi circuitry configured to connect to a network.

In an embodiment, the management server 120 collects a first dataset that is indicative of EV charging properties of each EV user of a plurality of EV users. Each EV user is associated with at least an identifier and at least one EV. An EV user is, for example, an owner of an EV. An EV user's identifier may be, for example, an ID number. It should be noted that each user may be associated with more than one EV. Therefore, each EV has its own identifier, allowing to distinguish between a plurality of EVs. Also, an EV user may have its own private EV charger, e.g., in an apartment building which may be used as an identifier to identify the user and thus, the user's EV charging properties may be collected and associated with the user. However, when the disclosed method is implemented in a public EV charging site, e.g., at a shopping center, the user's identity may be detected using a designated application that runs on the user's user device 160, radio-frequency identification (RFID) techniques, and so on. According to one embodiment, EV information for each EV of each EV user may be received by the management server 120. The EV information may be received as an input from the user device 160, e.g., through a designated application that is adapted to communicate with the management server 120 over the network 110. The EV information may indicate the type of EV charger the EV is compatible with, e.g., a one-phase charger, a three-phase charger, etc., the EV's battery capacity, and so on. According to a further embodiment, the EV information may be part of the first dataset.

The first dataset indicating the EV charging properties of each EV user may specify the time at which the user usually connects the EV to the EV charger, the time at which the user usually disconnects the EV from the EV charger, the EV user's average charging duration, the user's EV type, the user's EV properties, the EV battery capacity, charging speed of the user's EV, and so on. It should be noted that the first dataset may be collected from one or more sources, such as, the user device 160, e.g., from a designated application, the DB 170, the EV charger 130, and the like. For example, information regarding the time at which the user usually connects and disconnects from the EV charger, e.g., the EV charger 130, as well as the EV charging duration, may be collected from the EV charger 130, the DB 170, an application installed on the user's user device 160, and so on. For example, the user device 160 may be used for determining, e.g., using a global positioning system module, the time when the EV arrived at the EV charging site and when the EV left the EV charging site.

For example, in an apartment building, in which 30 EV chargers of 30 different users operate, the management server 120 collects the first dataset with respect to each user from the EV chargers 130 from the user devices 160 of the EV users, and so on. According to this example, the collected first dataset is utilized to determine the 30 users' EV charging properties and patterns which allows to predict the future usage of each user in different time frames, as further described herein.

In an embodiment, the management server 120 collects a second dataset that is indicative of electrical properties of an EV charging site. The EV charging site includes a plurality of EV chargers, e.g., the EV chargers 130 that are connected to an electric infrastructure of the EV charging site. Each of the EV chargers 130 is configured to charge at least one EV. It should be noted that some EV chargers are configured to charge two EVs simultaneously. The charging site may be located in an apartment building, workplace, shopping centers, and so on. The electrical properties of the EV charging site may specify, for example, the electrical load capacity of the site, real-time electrical consumption data, and so on. The second dataset that is indicative of the electrical properties of the EV charging site may be collected from, for example, one or more web sources, e.g., the web source 180, database 170, the EV chargers 130, and the like. For example, the database may store therein information indicating the electrical load capacity of the site. As another example, the real-time electrical consumption data may be collected from the active EV chargers 130 in the EV charging site, or from an external one or more electrical meters installed on the EV charging site's main or sub panels.

In an embodiment, the management server 120 collects a third dataset that is indicative of electricity prices in the region in which the EV charging site is located. Electricity prices may vary between different regions and countries. Also, the electricity prices may vary based on the time of day. For example, the price per 1 kWh could be cheaper at night between 10 pm and 6 am, compared to the price of 1 kWh at the rest of the day.

In an embodiment, the management server 120 determines whether at least a portion of the plurality of EV chargers 130 of the EV charging site was activated. It should be noted that each EV charger of the plurality of EV chargers 130 is activated by an EV user of the plurality of EV users. An activated EV charger is an EV charger for which all conditions to start charging are met. The conditions to start charging an EV may include one or more of the following: establishment of a physical connection between the EV charger and the EV through an EV charging cable, establishment of an authorized charging session for an authorized entity, e.g., user, e.g., by an authorization center, a combination thereof, and the like.

The management server 120 may be configured to monitor the state of each EV charger 130. To that end, the management server 120 may interface with all EV chargers 130 at the EV charging site to collect information such as the real-time state of each EV charger 130. The real-time state may indicate for example the number of kilowatts that is currently consumed by each EV charger 130 in the charging site. The management server 120 may use the network interface 129 to communicate with each EV charger 130 via the network 110. It should be noted that, each EV charger 130 may include, among other components, a network interface (not shown) that may be used for sending information, receiving information, and the like.

In an embodiment, the management server 120 generates an optimal EV charging plan for the EV charging site based on the first dataset, the second dataset, the third dataset and the activated EV chargers in the EV charging site. An activated EV charger 130 is an EV charger that is connected to a respective EV and has permission to start a charging session, e.g., for which all conditions to start charging are met. An optimal EV charging plan may have several goals such as: (a) to fulfill the charging requirements of each EV user of the plurality of EV users at the EV charging site by the time the EV user wishes to leave the EV charging site, (b) to charge all the EV at the lowest electricity price, (c) to prevent a power outage. In an embodiment, the management server 120 applies a set of rules to the collected datasets and the information regarding the active EV chargers to determine the optimal EV charging plan for the EV charging site considering the real-time state of each of the plurality of EV chargers at the EV charging site.

It should be noted that each of the first, second and third datasets includes at least one parameter, e.g., departure time-time at which the user usually disconnects the EV from the EV charger, and a respective parameter value, e.g., 8 am. Also, the state of each EV charger 130 may also be monitored using a set of parameters, e.g., charging speed and parameters values, e.g., 11 kWh, related to each EV charger 130. According to one embodiment, the management server 120 may be configured to assign a weight to each parameter, e.g., departure time, average amount of kWh the user needs, electricity prices, and so on. The weights are represented by numbers that correspond to the strength or weakness of a given parameter. The weights assigned to each parameter affect the EV charging plan. For example, in case the weight of the parameter associated with the number of kWh each EV user needs, is relatively high compared to weights of other parameters, the EV charging plan may determine that all EV chargers must leave the site with a full EV battery. Referring to the same example, it should be noted that by assigning the parameter of the number of kWhs each EV user needs with a relatively high weight, and the electricity price parameter with a relatively low weight, charging the EV of the EV users in the site may be charged when electricity is expensive. The strength or weakness of a parameter may correspond to its relative importance to the user, where a more important parameter has a greater strength.

In an embodiment, the management server 120 schedules the operation of each activated EV charger 130 in the EV charging site based on the optimal EV charging plan. Scheduling the operation of the active EV chargers 130 may be achieved by the management server 120 using the scheduling engine 127. To that end, the scheduling engine 127 may receive as an input the first dataset, the second dataset and the third dataset, as well as the real-time state of each active EV chargers 130 at the EV charging site and the identity of each user that is associated with an EV charger 130. The scheduling engine 127 may be adapted to apply a set of rules to the inputs, i.e., collected data, to generate an optimal EV charging plan. According to further embodiment, the management server 120 uses the scheduling engine 127 to apply a supervised or unsupervised machine learning model to the collected inputs to generate the optimal EV charging plan for charging the activated EV chargers 130 in the EV charging site.

For example, the first dataset that is collected with respect to ten EV users of the same EV charging site indicates that the first user usually connects the EV to the EV charger at 7 pm and disconnects, i.e., leaves the EV charging site, at 10 am, the second user usually connects the EV to the EV charger at 11 pm and disconnects at 5 am, the third user usually connects the EV to the EV charger at 9 pm and disconnects at 2 pm, and seven other EV users usually connect their EVs to their EV chargers at 9 pm and disconnect at 7:30 am. In addition, the first dataset also indicates that the EV of the first user usually consumes 30 kWh, the EV of the second user usually consumes 28 kWh, the EV of the third user usually consumes 15 kWh, the EV of the fourth user usually consumes 33 kWh, the EV of the fifth user usually consumes 50 kWh, and so on. For this example, the second dataset indicates the electrical load capacity of the EV charging site, i.e., the maximum electrical power that can be provided by the electric infrastructure of the EV charging site at the same time, is 30 kW. Also, for this example, the third dataset indicates that the electricity price is the cheapest between 1 am and 4 am. Thereafter, by monitoring all the EV chargers 130 in the EV charging site, the management server 120 determines that EV chargers 1 through 5, and EV chargers 8 and 10, are each currently active, i.e., they are connected to an EV and have permission to start charging. In response, the management server 120 uses the scheduling engine 127 to generate an optimal EV charging plan for all the active EV chargers, e.g., all seven. Then, the management server 120 schedules the operation of each active EV charger 130 based on the optimal EV charging plan.

In an embodiment, the management server 120 continuously monitors the first dataset, the second dataset, the third dataset and the plurality of EV chargers 130 in real-time. As noted above, each dataset includes at least one parameter, e.g., time at which the user usually disconnects the EV form the EV charger, and a respective parameter value, e.g., 8 am. Thus, the management server 120 may be configured to continuously monitor the parameter values of each dataset, i.e., of the first, second, and third datasets, as well as the state of each EV charger 130 at the EV charging site. The state of each EV charger 130 may also be monitored using a set of parameters, e.g., charging speed, and parameters values, e.g., 11 kWh, related to each EV charger 130.

When the management server 120 determines that one or more parameters values of the one or more datasets have been changed and/or the status of the active EV chargers in the EV charging site has been changed, the management server 120 adjusts the optimal EV charging plan in real-time. For example, an initial optimal EV charging plan is used for scheduling the charging of 10 active EV chargers. Then, one hour after the optimal plan was generated another three EVs connect to their EV chargers at the same EV charging site. According to the same example, the management server 120 adjusts the optimal EV charging plan in real-time to ensure that (a) the charging requirements of each EV user of the now 13 EV users are fulfilled by the time each of the EV users wish to leave the EV charging site, (b) all the EVs are charged at a time in which the electricity prices are cheapest, and (c) to prevent a power outage at the EV charging site. According to another embodiment, the management server 120 reschedules the charging of the EVs in the site based on the adjusted EV charging plan.

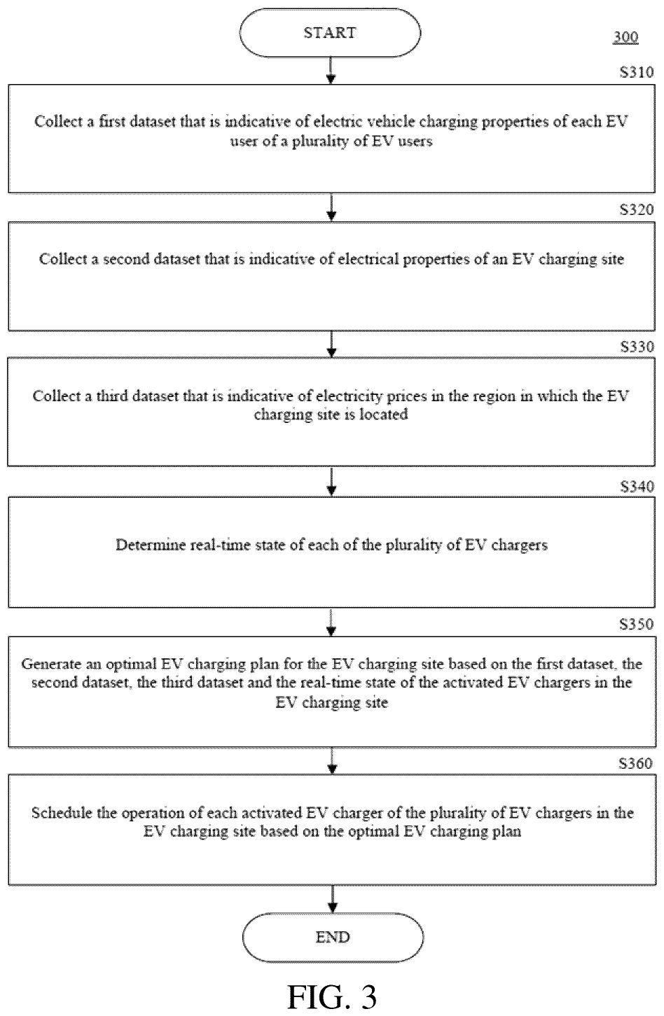

FIG. 3 shows a flowchart of an illustrative process for performing predictive electrical load management for a plurality of EV chargers, according to an embodiment. The disclosed method may be executed by the management server 120 of FIG. 2.

At S310, a first dataset that is indicative of EV charging properties of each EV user of a plurality of EV users, is collected. Each EV user is associated with at least an identifier and at least one EV. An EV user is, for example, an owner of an EV. An EV user's identifier may be for example, an ID number. The first dataset indicating the EV charging properties of each EV user may specify the time at which the user usually connects the EV to the EV charger, the time at which the user usually disconnects the EV from the EV charger, the EV user's average charging duration, the user's EV type, the user's EV properties, the EV battery capacity, charging speed of the user's EV, and so on. According to one embodiment, information for each EV of each EV user may be received by the management server 120. The EV information may be received as an input from the user device 160, e.g., through an application that is adapted to communicate with the management server 120 over the network 110. The EV information may indicate the type of EV charger the EV is compatible with, e.g., a one-phase charger, a three-phase charger, etc., the EV's battery capacity, and so on. According to further embodiment, the EV information may be part of the first dataset.

At S320, a second dataset that is indicative of electrical properties of an EV charging site, is collected. The EV charging site includes a plurality of EV chargers that are connected to an electric infrastructure of the EV charging site. Each of the EV chargers 130 is configured to charge at least one EV. The charging site may be located in an apartment building, workplace, shopping centers, and so on. The electrical properties of the EV charging site may specify, for example, the electrical load capacity of the site, real-time electrical consumption data, and so on.

At S330, a third dataset indicating electricity prices in the region in which the EV charging site is located, is collected. Electricity prices may vary between different regions and countries. Also, the electricity prices may vary based on the time of day. For example, the price per 1 kWh could be cheaper at night between 10 pm and 6 am, compared to the price of 1 kWh at the rest of the day.

At S340, real-time state of each EV charger in the site is determined. That is, each active EV charger, which is associated with a specific EV user, is detected and real-time parameters values may be collected with respect to each active EV charger. The real-time parameters values facilitate determination of real-time state of all the active EV charger at the EV charging site. The real-time state may indicate for example the number of kilowatts that is currently consumed by each EV charger 130 in the charging site, the number of EV charging, the identities of the EV users associated with each active EV charger, and so on.

At S350, an optimal EV charging plan is generated for the EV charging site based on the first dataset, the second dataset, the third dataset and the real-time state of the activated EV chargers in the EV charging site. An activated EV charger is an EV charger that is connected to a respective EV and has permission to start charging. An optimal EV charging plan has several goals such as: (a) to fulfill the charging requirements of each EV user of the plurality of EV users at the EV charging site by the time the EV user wishes to leave the EV charging site, (b) to charge all the EV at the cheapest electricity price, (c) to prevent a power outage in the EV charging site. In an embodiment, the management server 120 applies a set of rules to the collected datasets and the information regarding the real-time state of the active EV chargers to determine the optimal EV charging plan. According to another embodiment, a supervised or an unsupervised machine learning model may be applied to the collected inputs, e.g., the datasets and the information regarding the real-time state of the active EV chargers, to generate the optimal EV charging plan for charging the activated EV chargers in the EV charging site.

At S360, the operation of each activated EV charger in the EV charging site is scheduled based on the optimal EV charging plan.

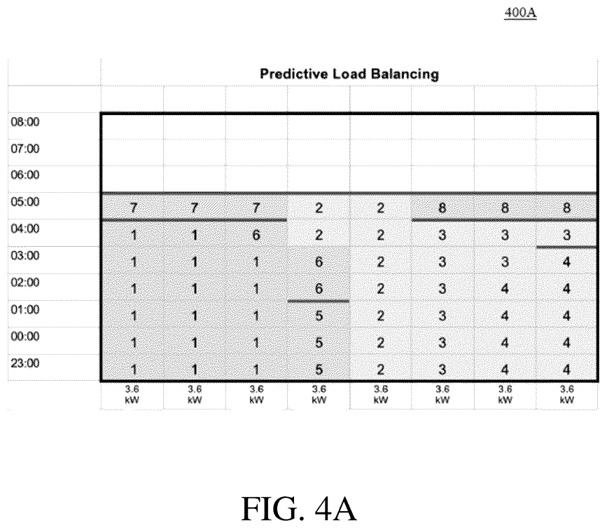

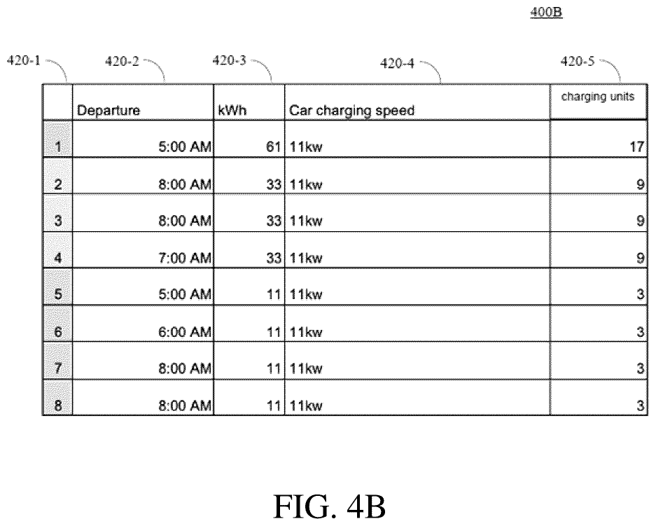

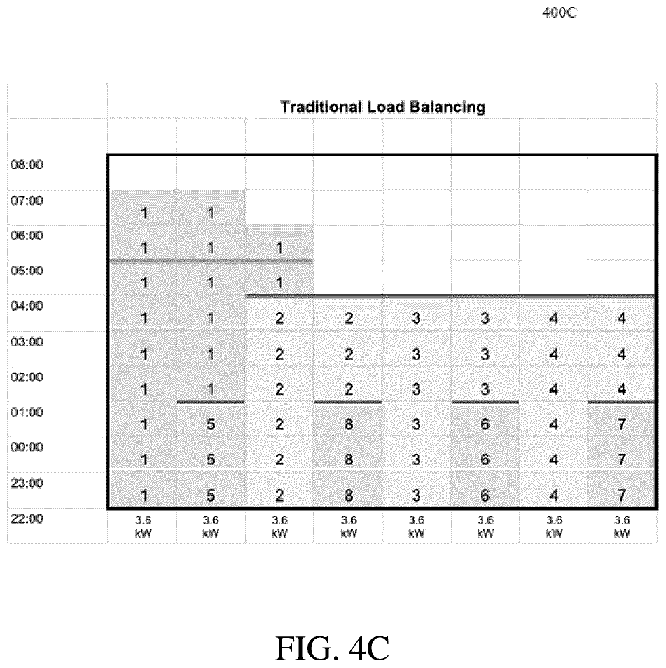

FIG. 4A is an illustrative representation of an optimal EV charging plan for a plurality of EV chargers of an EV charging site, according to an embodiment. Based on the collected first, second and third datasets which were further discussed hereinabove, an optimal EV charging plan is generated. As noted above, an optimal EV charging plan has several goals such as: (a) to fulfill the charging requirements of each EV user of the plurality of EV users at the EV charging site by the time the EV user wishes to leave the EV charging site, (b) to charge all the EV at the lowest electricity price, (c) to prevent power outage. Reference is made to illustrative data shown in FIG. 4B, in which the number of each EV user is shown in column 420-1, the predicted departure time of each EV user is shown in following column 420-2, the predicted amount of kWh that each EV user needs is shown in column 420-3, the EV charging speed is shown in column 420-4, the required number of charging units assigned to the EV user in the plan of FIG. 4A, where each charging unit is represented by a cell in the EV charging plan, is shown in column 420-5. Each charging unit, i.e., each cell in the EV charging plan, is a predetermined amount of electrical power, e.g., 3.6 kW, that is provided for a predetermined amount of time, e.g., one hour.

Referring back to FIG. 4A, the X axis represents the electric power, i.e., kW, and the Y axis represents the time intervals. The number shown in each of the cells is indicative of a unique EV to which the charging unit represented by the cell is allocated. In the example of FIG. 4A, each cell indicates a charging unit corresponding to charging 3.6 kW in one hour.

For example, the first EV, i.e., EV 1, usually leaves at 5 am, needs 61 kWh, charges at 11 kw and therefore 17 charging units are required to complete the charging of EV 1 by 5 am which is represented in the plan of FIG. 4A by the 17 cells containing a 1. The second EV, i.e., EV 2, usually leaves at 8 am, needs 33 kWh, charges at 11 kw and therefore it requires 9 charging units represented by the 9 cells containing a 2 that are required to complete the charging of EV 2 by 8 am. The third EV, i.e., EV 3, usually leaves at 8 am, needs 33 kWh, charges at 11 kw and therefore it requires 9 charging units represented by the 9 cells containing a 3 to complete the charging of EV 3 by 8 am.

The fourth EV, i.e., EV 4, usually leaves at 7 am, needs 33 kWh, charges at 11 kw and therefore it requires 9 charging units represented by the 9 cells containing a 4 complete the charging of EV 4 by 7 am. The fifth EV, i.e., EV 5, usually leaves at 5 am, needs 11 kWh, charges at 11 kw and therefore it requires 3 charging units represented by the 3 cells containing a 5 to complete the charging of EV 5 by 5 am. The sixth EV, i.e., EV 6, usually leaves at 6 am, needs 11 kWh, charges at 11 kw and therefore it requires 3 charging units represented by the 3 cells containing a 6 to complete the charging of EV 6 by 6 am.

The seventh EV, i.e., EV 7, usually leaves at 8 am, needs 11 kWh, charges at 11 kw and therefore it requires 3 charging units represented by the 3 cells containing a 7 to complete the charging of EV 7 by 8 am. The eighth EV, i.e., EV 8, usually leaves at 8 am, needs 11 kWh, charges at 11 kw and therefore it requires 3 charging units represented by the 3 cells containing an 8 to complete the charging of EV 8 by 8 am.

It should be noted that when traditional load balancing systems, i.e., known prior art solutions, are required to provide more electric power than it possibly can, the traditional systems usually divide the electric power equally between the different EV chargers in the charging site, without taking into consideration the users' charging behavior patterns. Therefore, the electric power provided to each EV charger is limited and relatively low, and the risk that charging of the EVs will not be completed by the time the EV users need to leave, i.e., their desired departure time, increases.

Reference is now made to FIG. 4C which shows an illustrative representation of a charging plan 400C based on a traditional EV charging process for a plurality of EV chargers. The same illustrative data shown in FIG. 4B is employed for the plan 400C of FIG. 4C. Thus, the first EV, i.e., EV 1, usually leaves at 5 am, needs 61 kWh, chargers at 11 kw and therefore 17 charging units of 3.6 kW, that is provided an hour (i.e., cells) are required to complete the charging of EV 1 by 5 am. However, as noted above, when using a traditional load balancing system, the system divides the electric power equally between the EV chargers in the EV charging site. That is, the electrical capacity of the EV charging site is equally divided between the eight active EV chargers, such that instead of providing the first EV charger with 10.8 kWh at the beginning of the charging, as is shown in the illustrative plan of FIG. 4A, the traditional load balancing system provides to the first EV only 3.6 kWh for three hours. After few hours, when other EV chargers in the EV charging site complete their operation, e.g., the fifth EV charger, the eighth EV charger, the sixth EV charger, and the seventh EV charger, the first EV charger can start consuming 7.2 kWh, instead of 3.6 kWh, and when more EV chargers complete their operation, e.g., six hours from the beginning of the charging, the first EV charger can consume 10.8 kWh.

Disadvantageously, under such a traditional plan, EVI will not be fully charged and ready to leave by 5 AM as required.

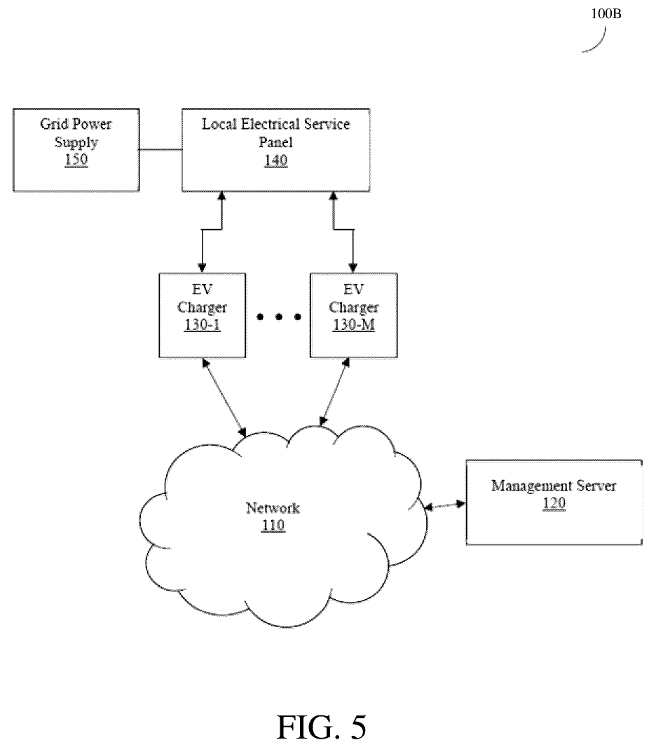

FIG. 5 shows an illustrative network diagram 100B for use in implementing an embodiment of the disclosure. FIG. 5 shows a management server 120 and a plurality of electric vehicle chargers 130-1 through 130-M, where M is an integer equal to or greater than 1, hereinafter referred to as EV charger 130 or EV chargers 130, merely for simplicity, which are all communicatively coupled by a network 110. The network 110 may be a wireless network, a wired network, a wide area network (WAN), a local area network (LAN), or any other kind of applicable network, as well as any combination thereof.

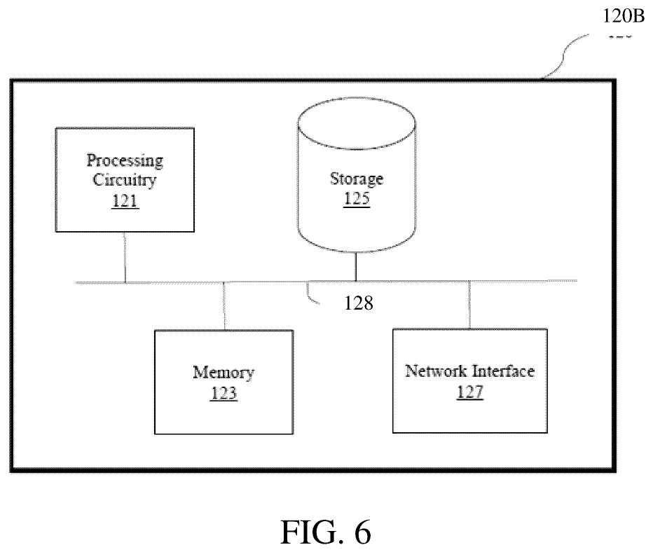

The management server 120 may include hardware and software that enables the management server 120 to apply different charging policies to the EV chargers, e.g., the EV chargers 130, update the charging policies, modify the charging policies, send instructions to the EV chargers, receive information from the EV chargers, and the like. The components of the management server 120 are further described with respect to FIG. 6. In an embodiment, the management server 120 is deployed in a cloud computing platform, such as Amazon® AWS or Microsoft® Azure.

By executing the disclosed method, that is further discussed herein below, the management server 120 prevents an electrical circuit overload in a charging site in which a plurality of EV chargers is located. To that end, and as further discussed herein below, the management server 120 continuously monitors the connectivity quality between the EV chargers and the management server 120, monitors real-time electric energy consumption of the EV chargers, receive inputs regarding a predetermined electrical capacity of an EV charging site, and applies different charging policies to different EV chargers.

It should be noted that when unstable connectivity conditions occur between EV chargers in a charging site and a traditional central control system, the traditional central control system does not detect cases such as a larger number than possible of EVs that are trying to get a relatively high amperage. In such cases, the larger number of EVs trying to get relatively high amperage may be more than the local charging site infrastructure is able to provide. Therefore, an electrical circuit overload may be caused.

Each of the EV chargers 130 is a piece of equipment that supplies electrical power for charging plug-in EVs. An EV charger is usually connected to a local electrical service panel 140, while the local electrical service panel is connected to a grid power supply, 150, from which the electric power is provided to the EV charger 130. The local electrical service panel 140 is a central distribution point that connects the external wires coming from the grid and the internal electrical wires of the electrical system of the EV charging site. The grid power supply 150 is an interconnected network for electricity delivery from electricity producers to electricity consumers.

The EV chargers 130 further include a network interface (not shown) by which the EV chargers 130 are able to communicate with, for example, the management server 120. EV chargers are usually located in shopping centers, government facilities, as well as at residences, workplaces, and hotels. In many cases there are multiple EV chargers that operate at the same time at such EV charging sites and therefore an efficient allocation of the electric power among the active EV chargers is required in order to prevent power outage.

FIG. 6 is an illustrative block diagram of a management server 120B according to an embodiment. The management server 120B includes a processing circuitry 121 coupled to a memory 123, a storage 125, and a network interface 127. The components of the management server 120B may be communicatively connected via a bus 128.

The processing circuitry 121 may be realized as one or more hardware logic components and circuits. For example, and without limitation, illustrative types of hardware logic components that can be used, include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 123 may be volatile, e.g., RAM, etc., non-volatile, e.g., ROM, flash memory, etc., or a combination thereof. In one configuration, computer readable instructions to implement one or more embodiments disclosed herein may be stored in the storage 125.

In another embodiment, the memory 123 is configured to store software. Software shall be construed broadly to mean any type of instructions, whether referred to as software, firmware, middleware, microcode, or hardware description language. Instructions may include code in formats such as source code, binary code, executable code, or any other suitable format of code. The instructions, when executed by the one or more processing circuitry 121, cause the processing circuitry 121 to perform the various processes described herein.

The storage 125 may be magnetic storage, optical storage, and the like, and may be realized, for example, as flash memory or other memory technology, or any other medium which can be used to store the desired information.

The network interface 127 is configured to connect to a network. The network interface 127 allows the management server 120 to communicate with at least the electric vehicle (EV) chargers, for the purpose of, for example, applying electric charging policies to EV chargers, updating electric charging policies, retrieving data from the EV chargers, the DB 170, and the like. The network interface 127 may include a wired port or a wireless port, e.g., an 802.11 compliant Wi-Fi circuitry configured to connect to a network.

In an embodiment, the management server 120 applies an EV baseline charging policy to a plurality of EV chargers that are located in a charging site. The EV baseline charging policy is a predetermined plan which limits the amperage that the EV charger is able to provide to an EV when the connectivity between the EV charger and the management server 120 is below a predetermined threshold, as further discussed herein below. The EV baseline charging policy is applied to the plurality of EV chargers for a first predetermined period. The first predetermined period may be, for example, a time window such as 10 minutes, 15 minutes, and the like. For example, each EV charger to which the EV baseline charging policy is applied will be able to provide no more than 7 amperes for 30 minutes. In an embodiment, in an initial setup stage, the EV baseline charging policy is applied to all EV chargers at the charging site.

According to another embodiment, the EV baseline charging policy indicates a range of amperes that may be provided by each EV charger to which the baseline policy applies. For example, the range may be between 6 and 8 amperes. It should be noted that the allocation of electric power to the EV chargers in the charging site may vary through time based on the actual electric power consumption at the charging site. To that end, the management server 120 may be configured to continuously calculate the actual electric power consumption of each EV charger as compared to the electrical capacity of the entire charging site in order to provide electrical energy to the EV chargers while preventing a power outage. To that end, although the EV baseline charging policy is designed to limit the amperage provided by each EV charger, there is no minimum number of amperes that must be provided. For example, the management server 120 may determine that although the maximum number of amperes that can be provided by a first EV charger to which the EV baseline charging policy applies is 8, the actual number of amperes provided by the first EV charger will be lower, and even zero, due to the real-time electricity consumption and the electrical capacity of the charging site.

Applying the EV baseline charging policy may be achieved by sending instructions from the management server 120 by the network interface 127 via the network 110 to the EV chargers 130 that are located at a charging site. Each EV charger 130 may include, among other components, a network interface (not shown) that may be used for receiving the EV baseline charging policy from the management server 120.

In an embodiment, the management server 120 continuously monitors in real-time the connectivity quality between the management server and each of the plurality of EV chargers 130 in the charging site. Monitoring the connectivity quality between the management server 120 and the EV chargers 130 may be achieved using, for example, a WebSocket protocol. According to one embodiment, the management server 120 determines whether communication between the management server 120 and a respective EV charger 130 exists or not. According to another embodiment, connectivity quality may be measured by determining the number of not received packets in a time window, which may be a sliding time window, based on a packet numbering arrangement. If the number of packets received is above a threshold, which may be represented by a percentage of transmitted packets, it may be determined that the connectivity quality is good. Likewise, If the number of packets received is below a threshold, which may be represented by a percentage of transmitted packets, it may be determined that the connectivity quality is poor. In yet another embodiment, the connectivity quality may be based on the response time determined by a communication test.

In an embodiment, the management server 120 overrides the EV baseline charging policy of at least one EV charger of the plurality of EV chargers with a first EV active charging policy upon determination that (a) all conditions to start charging were met and (b) connectivity quality between the at least one EV charger and the management server is above a predetermined threshold. The conditions to start charging an EV may include one or more of the following: establishment of a physical connection between the EV charger and the EV through an EV charging cable, establishment of an authorized charging session by an authorized entity, e.g., user, a combination thereof, and the like. It should be noted that the set of conditions required to start charging an EV may vary based on, for example, the EV's type.

The first EV active charging policy is a predetermined plan which allows the EV charger to which the active policy is applied to provide relatively high amperage as compared to the amperage provided by the EV baseline charging policy while limiting the duration during which the relatively high amperage is provided to the EV charger. The first EV active charging policy may be applied to the plurality of EV chargers for a second predetermined period, such as, 10 minutes, 15 minutes, and the like.

The first EV active charging policy allows the EV charger to which it is applied to provide a relatively high amperage for a second predetermined period while taking into account the real-time electrical consumption in the charging site and the actual electrical capacity of the charging site. For example, each EV charger to which the first EV active charging policy is applied will be able to provide 10A, 13A, 15A and so on, in accordance with the real-time electrical consumption at the charging site and the actual electrical capacity of the charging site for a second predetermined period of 15 minutes.

In an embodiment, the management server 120 continuously monitors in real-time the electrical energy consumption of each EV charger of the plurality of EV chargers 130. Also, the management server 120 receives, or collects, information regarding the electrical capacity of the charging site. The electrical capacity of the charging site indicates the maximum amount of electrical energy that can be distributed amongst the EV chargers 130 at the charging site. In addition, the management server 120 may be configured to analyze in real-time the electrical energy consumption of each EV charger of the plurality of EV chargers 130 with respect to the electrical capacity of the charging site. The management server 120 determines, based on the analysis, for each EV charging policy, e.g., baseline or active, that is applied to a respective EV charger, a maximal allocation of electrical energy for the predetermined period of the EV charging policy.

Applying the EV active charging policy, instead of the EV baseline charging policy, may be achieved by sending instructions using the management server 120, e.g., using the network interface 127, via the network 110 to the EV chargers 130 that are located at a charging site. It should be noted that each EV charger 130 may include, among other components, a network interface (not shown) that may be used for receiving the EV active charging policy from the management server 120.

As noted above, there are two conditions for overriding the EV baseline charging policy that was applied to a first EV charger with the first EV active charging policy. The first condition is that the EV charger 130 is currently active and can provide electricity to an EV, i.e., all conditions for charging were met. The second condition is that the connectivity quality between the first EV charger 130 and the management server 120 is above a predetermined threshold. In an embodiment, the connectivity quality may be based on response time achieved during a communication test. Thus, the predetermined threshold may be a prescribed maximum response time that must not be exceed during a communication test. Thus, for example, the predetermined response time threshold may be 0.4 milliseconds. In such an example, if the response time is below 0.4 milliseconds the connectivity quality is considered to be good and hence above the predetermined threshold for quality. According to another embodiment, the second condition is that the connectivity between the first EV charger 130 and the management server 120 simply exists. The management server 120 is configured to the determine whether the first EV charger 130 is currently active and providing electricity to an EV by receiving information from the first EV charger 130 via the network 110. As noted above, the first EV active charging policy overrides the EV baseline charging policy, that was initially applied to the first EV charger, for a limited period.

In an embodiment, the management server 120 applies a second EV active charging policy for the at least one EV charger 130 upon determination that (a) the first EV active charging policy was revoked, (b) connectivity quality between the at least one EV charger 130 and the management server 120 is above the predetermined threshold, and (c) charging has not been completed yet. The second EV active charging policy is a predetermined plan which allows the EV charger to which the active policy is applied to provide a relatively high amperage as compared to the EV baseline charging policy while limiting the duration at which the relatively high amperage is provided to the EV charger to a third predetermined period.

In an embodiment, the management server 120 is configured to modify each of the EV active charging policies, e.g., the first EV active charging policy before the predetermined period associated with the policy ends. Such modification may be performed by the management server 120 based on power consumption changes in the charging site. For example, each EV charger of three EV chargers of a charging site, provides 13A to its EV based on an active charging policy applied to each EV charger for 20 minutes. According to the same example, eight minutes after the 20 minutes period has started, the charging of one EV, of the three EVs, is completed. Therefore, even though the EV active charging policies of the other two EV chargers still apply, the management server 120 calculates the power consumption in the charging site and modifies each of the two EV active charging policies that still apply so that the two EV chargers will be able to provide 16A instead of 13A.

As noted above, the EV first active charging policy is applied for a second predetermined period and expires after that. Thus, close to the end of the second predetermined period, the management server 120 checks the EV charging status, e.g., real-time electrical energy consumption, as well as the connectivity quality between the at least one EV charger 130 and the management server 120. When the connectivity quality between the at least one EV charger 130 and the management server 120 is above the predetermined threshold, and the EV charging is still in process, the management server 120 applies a second EV active charging policy to the EV charger 130. It should be noted that the properties of the first EV active charging policy and the properties of the second EV active charging policy may be identical or different from each other. That is, the properties of the second EV active charging policy applied to an EV charger for a new period, e.g., a third period, may not necessarily be identical to the properties of the first EV active charging policy applied to the same EV charger for a previous period, e.g., the second period. For example, the amount of electrical energy that was allocated to the first EV charger 130 when the first EV active charging plan applied may be higher or lower than the amount of electrical energy that was allocated to the same EV charger 130 when the second EV active charging plan applied, and the particular amount of electrical energy allocated for the second EV active charging plan is based on the real-time electrical energy consumption of each EV charger 130 with respect to the electrical capacity of the charging site.

For example, when the first EV active charging policy applied to a first EV charger, the first EV charger was able to provide 16A to the EV however, when the second EV active charging policy applied to the same EV charger, e.g., 10 minutes afterwards, the same EV charger was able to provide only 13A to the EV due to the real-time consumption at the site and the maximum electrical capacity of the charging site.

For example, the first EV active charging policy is applied for 15 minutes, which corresponds to the second predetermined period, and then after the conditions that were previously discussed are met, the second EV active charging policy is applied for a subsequent 15 minutes which corresponds to the third predetermined period. Thereafter, the management server 120 checks, once again, the connectivity quality between the at least one EV charger 130 and the management server 120, and the EV charging status, e.g., electrical energy consumption of each EV charger 130 at the charging site. It should be noted that the lengths of the first, second and third predetermined periods may be identical or different from each other.

In an embodiment, when the third predetermined period during which the second active EV charging policy is in effect ends and the connectivity quality between the at least one EV charger 130 and the management server 120 is below the predetermined threshold, the second active EV charging policy is automatically overridden so that it has a baseline EV charging policy. To that end, the EV baseline charging policy, i.e., the policy that is initially applied to each of the EV chargers, includes at least one rule which enables the EV baseline charging policy to override the EV active charging policy. Similar to the EV active charging policy, the EV baseline charging policy may have different properties when applied for a new period. That is, while the amperage that may be provided by an EV charger to which the EV baseline charging policy is initially applied is 6 amps, the maximum amperage that may be provided by an EV charger to which the EV baseline is again applied a few minutes later is 7 amps. The difference may be the result of changes in the real-time electrical consumption at the charging site and/or the electrical capacity of the charging site.

It should be noted that each of the EV baseline charging policy and the EV active charging policy may be different when applied to different EV chargers or at different charging sites. For example, the same type of policy, such as the EV baseline charging policy, may have different properties when applied to a first EV charger than when applied to a second EV charger. As another example, the same type of policy, such as the EV active charging policy, may be different when applied at a first charging site than when applied at a second charging site.

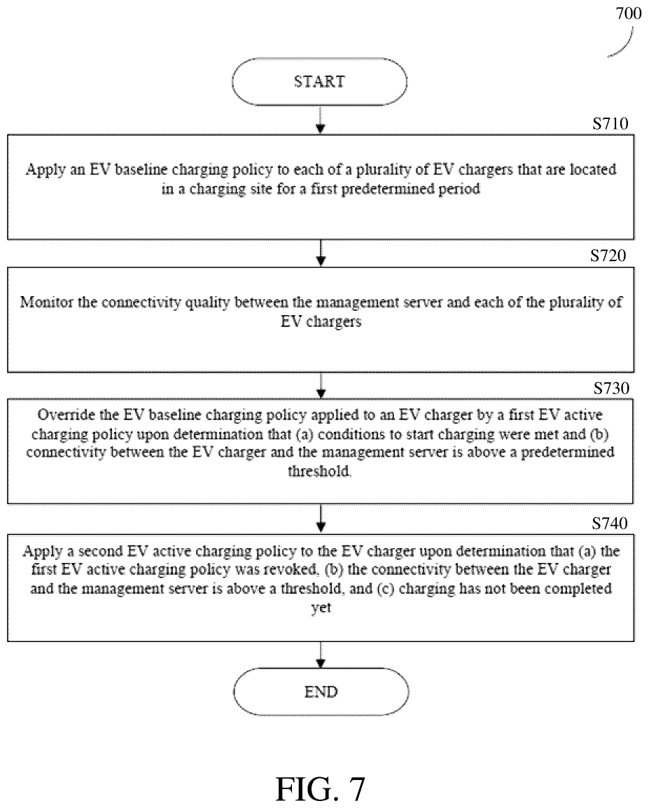

FIG. 7 shows a flowchart 700 of an illustrative method for managing electrical load for a plurality of electric vehicles (EV) chargers when connectivity may be unstable, according to an embodiment. The disclosed method may be executed by the management server 120 of FIG. 5 and FIG. 6.

It should be noted that when connectivity between EV chargers in an EV charging site and a traditional central control system, i.e., known central control system is unstable, the traditional central control system may not be able to detect that a larger number than possible of EV chargers are trying to provide a relatively high amperage, which may be more than the local site's infrastructure is able to properly provide. Therefore, a power outage may be caused. Advantageously, the embodiments disclosed herein above and below provide a solution for that deficiency by introducing a method for managing electrical load for a plurality of electric vehicles (EV) chargers when the connectivity quality may be poor.

At S710, an EV baseline charging policy is applied to a plurality of EV chargers that are located in a charging site. The EV baseline charging policy is a predetermined plan which limits the amperage that the EV charger is able to provide to the EV. According to one embodiment, the EV baseline charging policy is applied to the plurality of EV chargers for a first predetermined period. The EV baseline charging policy may be applied to all EV chargers at the charging site in a setup stage of the EV chargers.

At S720, the connectivity quality between the management server 120 and each of the plurality of EV chargers 130 in the charging site is monitored. Monitoring the connectivity quality may be achieved using, for example, a WebSocket protocol. Monitoring the connectivity quality may be performed in real-time.

At S730, the EV baseline charging policy that was initially applied to at least one EV charger, e.g., the EV charger 130-1, of the plurality of EV chargers, is overridden by a first EV active charging policy upon determination that (a) the all conditions to start charging were met and (b) connectivity quality between the at least one EV charger and the management server, e.g., the management server 120, is above a predetermined threshold. The conditions to start charging an EV may include one or more of the following: establishment of a physical connection between the EV charger and the EV through an EV charging cable, establishment of an authorized charging session by an authorized entity, e.g., user, a combination thereof, and the like. The first EV active charging policy is a predetermined plan which allows the EV charger to which the active policy is applied to provide relatively a high amperage as compared to the EV baseline charging policy while limiting the duration at which the relatively high amperage is provided to the EV charger, to a second predetermined period.

At S740, a second EV active charging policy is applied for a third predetermined period to the at least one EV charger, e.g., EV charger 130 upon determination that (a) the first EV active charging policy was revoked, (b) connectivity quality between the at least one EV charger and the management server, e.g., the management server 120, is above the predetermined threshold, and (c) charging has not been completed yet. However, when the second predetermined period of the first active EV charging policy ends and the connectivity quality between the at least one EV charger and the management server is below the predetermined threshold, the first active EV charging policy is automatically overridden by a baseline EV charging policy. To that end, both the EV baseline charging policy and the EV active charging policy may include at least one rule allowing the EV baseline charging policy to override the EV active charging policy. It should be noted that S720-S740 may be performed repetitively by the management server 120.

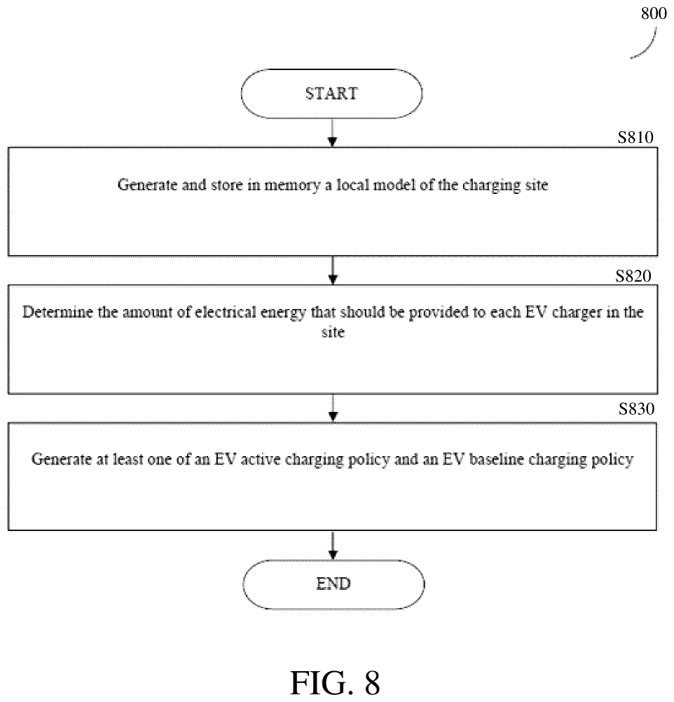

FIG. 8 shows a flowchart 800 for an illustrative method for associating EV charging policies with EV chargers of a charging site, according to an embodiment. The disclosed method may be executed by the management server 120 of FIG. 5 and FIG. 6.

At S810, a local model showing the energy consumption in the charging site is generated. The local model may be stored in a memory, e.g., the memory 123 shown in FIG. 6. The local model may provide information regarding the initial electric capacity of the charging site, real-time data about the energy consumption in the charging site, data about the connectivity quality between each EV charger and the management server, and the like.

At S820, the amount of electrical energy that should be provided to each EV charger in the site is determined based on the local model which includes information regarding the initial electric capacity of the charging site, real-time data about the energy consumption of each EV charger in the charging site, and data regarding the connectivity quality between the EV chargers and the management server.

At S830, at least one of an EV baseline charging policy and an EV active charging policy is generated. Generation of the EV charging policies may include applying a predetermined set of rules and/or a machine learning model, e.g., a supervised ML model, to the collected data to generate a suitable EV charging policy, i.e., an active charging policy or a baseline charging policy, indicating the amperage that is provided during each period in which the EV active or baseline charging policies are applied. The process of applying the EV charging policies on the EV chargers is described in greater details with respect to FIG. 6 and FIG. 7.

For example, three EV chargers to which EV active charging policies have been applied and having the same limit of 16A, are charging at 13A due to the limited 40A electrical capacity of the charging site. According to the same example, when one of the three EV chargers completes its operation and the predetermined period ends, the new EV active charging policies that are applied to the two EV chargers that have not yet completed their operation may indicate that charging rate is increased to 16A as the total real-time consumption at the site decreases due to completion of the charging of the first EV.

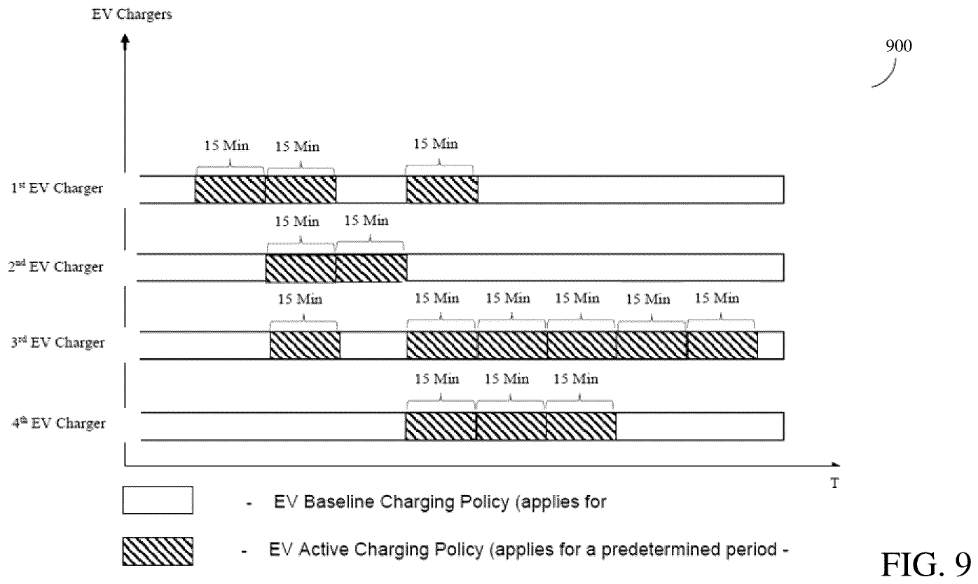

FIG. 9 shows an illustrative diagram 900 demonstrating an example of the management of the electrical load of a plurality of electric vehicles (EV) chargers when connectivity may be unstable, according to an embodiment. More specifically, FIG. 9 shows the charging policies through time of four EVs located at the same EV charging site that has four EV chargers, namely, 1st EV charger through 4th EV charger. Each empty section of the timeline of an EV charger indicates that an EV baseline charging policy is applied to that respective EV charger. As indicated above, the EV baseline charging policy is a predetermined plan which limits the amperage that the EV charger is able to provide to an EV when the connectivity between the EV charger and is applied typically when the management server 120 is below a predetermined threshold. Each square marked with oblique lines indicates that an EV active charging policy is applied to the respective EV charger. The EV active charging policy is a predetermined plan which allows the EV charger to which the active policy is applied to provide relatively high amperage as compared to the EV baseline charging policy while limiting the duration at which the relatively high amperage is provided to the EV charger.

As shown in FIG. 9, the first policy that is initially applied to the 1st EV charger is the EV baseline charging policy. It indicates that the 1st EV charger is not connected to an EV nor charging an EV. After a few minutes an EV connects to the 1st EV charger and the connectivity between the 1st EV charger and the management server, e.g., the management server 120 of FIGS. 5 and 6, is stable, i.e., above a predetermined threshold and therefore, a first EV active charging policy is applied to the 1st EV charger. The first EV active charging policy allows the 1st EV charger to provide, for example, 16 amperes for 15 minutes. After 15 minutes, the 1st EV charger is still charging and has a stable connectivity with the management server and so the management server monitors the electrical consumption at the charging site and calculates the electrical energy that should be provided to the 1st EV charger. Also, at the following period, e.g., a second period of 15 minutes, the management server generates a new, i.c., a second, EV active charging policy allowing 1st EV charger to provide 16A, as the electrical capacity of the site and the real-time electrical consumption, allow it. Then, five minutes after the second period has started, the connectivity between the 1st EV charger and the management server fails. However, although the connectivity has failed, the EV active charging policy still applies for the rest of the 15 minutes, i.e., until the end of the second predetermined period. When the second period ends, an EV baseline charging policy overrides the EV active charging policy and is applied to the 1st EV charger. Thus, the amperage provided to the 1st EV charger when the baseline policy applies is, for example, 7 amperes. When connectivity between the 1st EV charger and the management server, e.g., the management server 120 of FIGS. 5 and 6, is restored to the point that once again the connectivity quality is above the predetermined threshold and an EV is connected to the EV charger for charging, a new, i.c., third, EV active charging policy is generated by the management server and applied to the 1st EV charger. It should be noted that at the first 15 minutes charging period of the 1st EV charger, the 1st EV charger is the only charger that consumes electrical energy from the charging site and therefore, the EV active charging policy applied to that period allows the 1st EV charger to provide the highest electric energy, c.g., 16A.

Regarding the 2nd EV charger, the first policy that is initially applied to the 2nd EV charger is the EV baseline charging policy. After few minutes a first EV active charging policy applies to the 2nd EV charger allowing the 2nd EV charger to provide to the EV 16 amperes during a first predetermined period of 15 minutes. After 15 minutes, the 2nd EV charger is still charging and has a stable connectivity with the management server and so the management server monitors the electrical consumption at the charging site and calculates the electrical energy that should be provided by the 2nd EV charger. And so, at the following period, e.g., a second period of 15 minutes the management server generates a new, i.e., second, EV active charging policy allowing to provide 13A, considering the electrical capacity of the site and the real-time electrical consumption of the rest of the charging EV chargers in the charging site.

Regarding the 3rd EV charger, the first policy that is initially applied to the 3rd EV charger is the EV baseline charging policy. After 30 minutes a first EV active charging policy is applied to the 3rd EV charger allowing the 3rd EV charger to provide to the EV with 16 amperes for a first predetermined period of 15 minutes. Although the EV active charging policy applies for 15 minutes, after 14 minutes the connectivity fails for 6 minutes and so, the first EV active charging policy expires at the end of the first period. At that point, a new EV baseline charging policy is applied until connectivity is renewed between the management server and the 3rd EV charger. Then, when connectivity between the 3rd EV charger and the management server, e.g., the management server 120 of FIGS. 5 and 6, is restored and once again the connectivity quality is above the predetermined threshold and an EV is connected to the 3rd EV charger for charging, a second EV active charging policy is applied for another 15 minutes. Then, a third, a fourth, a fifth and a sixth EV active charging policies apply to the 3rd EV charger, one after another, upon determining that the connectivity continues to be stable, and charging has not been completed yet. It should be noted that the number of amperes the 3rd EV charger may be able to provide to the EV may vary from one period to another, i.e., between different policies or even when the same policy applies due to the need to take into account the real-time electrical consumption in the charging site and the electrical capacity of the charging site.

As for the 4th EV charger, the first policy that is initially applied to the 4th EV charger is the EV baseline charging policy. After one hour a first EV active charging policy is applied to the 4th EV charger allowing the 4th EV charger to provide to the EV 16 amperes along 15 minutes. Then, a third, and a fourth EV active charging policies are applied to the 3rd EV charger, one after another, as the connectivity quality is stable and charging has not been completed yet. At the third and last charging period, and although an EV active charging policy still applies for 15 minutes, the EV disconnects from the 4th EV charger such that, when the third charging period ends, i.e., last 15 minute period ends, a new EV active charging policy is not generated nor applied to the 4th EV charger. Instead, a new EV baseline charging policy overrides the third EV active charging policy and is applied to the 4th EV charger.

It should be noted that all, or part of the EV chargers may be charging at the same time. As noted herein, the management server, e.g., the management server 120 of FIGS. 5 and 6, may be configured to determine the allocated amount of amperes for each EV charger based on the limitations of the charging site's infrastructure and the real-time charging state of each of the EV at the charging site. Moreover, the number of EV chargers in a charging site may be greater than the number of EV chargers that are shown in the example diagram 900 without departing from the scope of the disclosure.

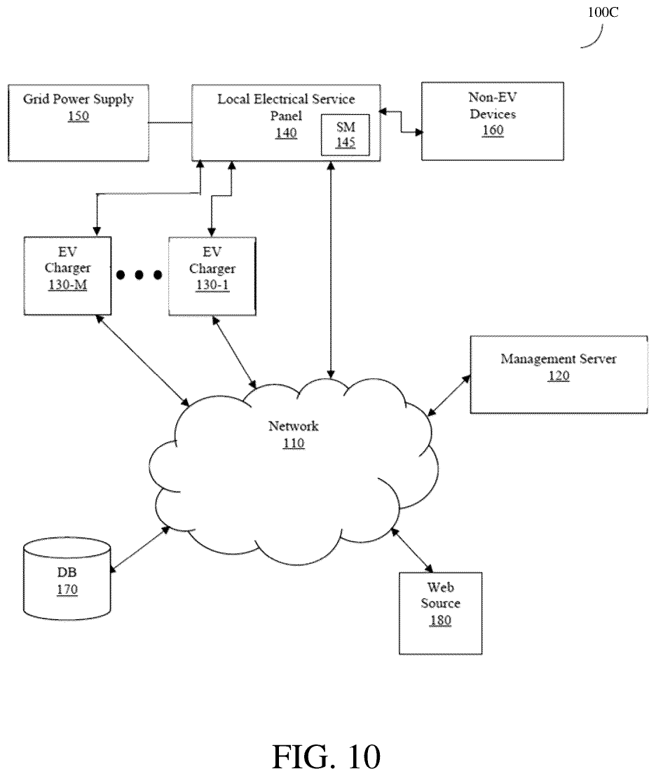

FIG. 10 shows an example network diagram 100C utilized to describe the various embodiments. In the example network diagram 100C, a management server 120, a plurality of EV chargers 130-1 through 130-M, where M is an integer equal to or greater than 1 (hereinafter referred to as EV charger 130 or EV chargers 130, merely for simplicity), a local electrical service panel 140, a database 170, one or more web sources 180, and one or more user devices 190 are communicatively connected to a network 110. The network 110 may be, or include, a wireless network, a wide area network (WAN), local area network (LAN), or any other kind of applicable network, as well as any combination thereof.

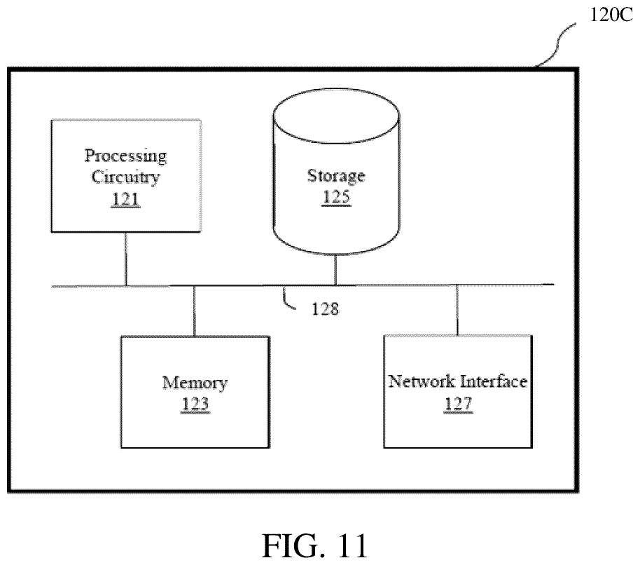

The management server 120 may include hardware and software layers which enable the management server 120 to collect datasets, analyze data, receive information, send instructions, and the like. The components of the management server 120 are further described with respect to FIG. 11. In an embodiment, the management server 120 is deployed in a cloud computing platform, such as Amazon® AWS or Microsoft® Azure.

The EV charger 130 is a piece of equipment that supplies electrical power for charging plug-in EVs. An EV charger is usually connected to a local electrical service panel, e.g., the local electrical service panel 140, while the local electrical service panel is connected to a grid power supply, e.g., the grid power supply 150, from which the electric power is provided to the EV charger 130. The local electrical service panel 140 is a central distribution point that connects the external wires coming from the grid and the internal electrical wires of the electrical system of the EV charging site. The grid power supply 150 is an interconnected network for electricity delivery from producers to consumers. A smart meter 145 may be connected to the local electrical service panel 140. The smart meter 145 is a piece of equipment allowing to monitor the electrical power consumption at the site in real-time. The smart meter 145 may communicate with the management server 120 over the network 110 using a network interface.

In addition to the EV chargers 130, a plurality of non-EV devices 160 may be connected to the local electrical service panel 140 which is connected to the grid power supply 150. The non-EV devices 160 may include for example, household appliances, elevators, lighting systems, and the like, of a site, e.g., a building. The electrical power consumed by the non-EV devices 160 is referred to as a non-EV load. That is, the non-EV load represents the electrical power that is consumed by electrical devices, i.e., the non-EV devices 160, excluding the EV chargers 130.

The EV chargers 130 further includes a network interface (not shown) by which the EV chargers 130 are able to communicate with, for example, the management server 120. EV chargers are usually located in shopping centers, government facilities, as well as at residences, workplaces, and hotels. In many cases there are multiple EV chargers that operate at the same time in such EV charging sites and therefore an efficient allocation of the electric power among the active EV chargers is required to enable a proper charging of the EV that are connected to the EV chargers.

The database 170 is a data warehouse that is configured to store, for example, data regarding electrical load capacity of the charging site, time of congestion, electrical current consumption of an EV load, electrical current consumption of non-EV load, and so on. The database 170 may be a centralized database, a cloud database, and the like.

The web source, or web sources, 180 maybe, or include a server, a website, a government website, a database, and the like. As an example, the web source 180 may be a website including weather forecast data, electricity prices, and the like.

FIG. 11 is an illustrative schematic diagram of the management server 120C according to an embodiment. The management server 120C includes a processing circuitry 121 coupled to a memory 123, a storage 125, and a network interface 127. In the embodiment, the components of the management server 120C may be communicatively connected via a bus 128.

The processing circuitry 121 may be realized as one or more hardware logic components and circuits. For example, types of hardware logic components that can be used, include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 123 may be volatile, e.g., RAM, etc., non-volatile, e.g., ROM, flash memory, etc., or a combination thereof. In one configuration, computer readable instructions to implement one or more embodiments disclosed herein may be stored in the storage 125.

In another embodiment, the memory 123 is configured to store software. Software shall be construed broadly to mean any type of instructions, whether referred to as software, firmware, middleware, microcode, or hardware description language. Instructions may include code in formats such as source code, binary code, executable code, or any other suitable format of code. The instructions, when executed by the one or more processing circuitry 121, cause the processing circuitry 121 to perform the various processes described herein.

The storage 125 may be magnetic storage, optical storage, and the like, and may be realized, for example, as flash memory or other memory technology, or any other medium which can be used to store the desired information.

The network interface 127 is configured to connect to a network, e.g., the network 110). The network interface 127 allows the management server 120 to communicate with at least the EV chargers 130, the local electrical service panel 140, the DB 170, and the like. The network interface 127 may be, or include, a wireless port, e.g., 802.11 compliant Wi-Fi circuitry configured to connect to a network.

In an embodiment, the management server 120 obtains a maximum electrical current supply value that can be provided to a site. The site includes a plurality of EV chargers, e.g., the EV chargers 130, as well as other electrical devices that are connected to an electric infrastructure of the site. Each of the EV chargers 130 is adapted to charge at least one EV. The site may be an apartment building, workplace, and so on. The maximum electrical current supply value that can be provided to a site indicates the maximum amount of electrical power that can be provided to the site. The maximum electrical current supply value that can be provided to a site may be stored in the memory 123.

In an embodiment, the management server 120 collects, over a first period, time series data of electrical current consumption of a non-EV load of the site. The time series data of the electrical current consumption of the non-EV load of the site indicates the amount of electrical power that is consumed at the site, during a certain time series by electrical devices, excluding the EV chargers 130. For example, the data of electrical current consumption of the non-EV load of the site is collected over a week and represents the electrical current consumed by household appliances, elevators, and the like over a week. According to the same example, the data of electrical current consumption of the non-EV load of the site indicates that on Monday at 7:00 pm the electrical current consumption of the non-EV load was 30 amperes, at 7:01 pm the electrical current consumption of the non-EV load was 28 amperes, at 7:02 pm the electrical current consumption of the non-EV load was 20 amperes. It should be noted that the time series data of electrical current consumption of the non-EV load of the site may be collected over an hour, a day, a week, a month, a quarter, a year, and so on. Thus, the time series data may be analyzed and manipulated to generate insights derived from the time series data, e.g., insights indicating the amount of electrical current consumption of non-EV load of the site at specific times that repeat within the first period. For example, the average electrical current consumption of non-EV load of the site on Tuesdays at a specific time, e.g., 10:7 am, may be determined based on analysis of the time series data.

According to another embodiment, additional information may be collected by the management server 120 with respect to the time series data of electrical current consumption of the non-EV load of the site, while collecting the time series data of electrical current consumption of the non-EV load of the site. The additional information may include, for example, environmental data, such as the temperature, humidity, and the like at the site. The purpose of collecting the additional information, e.g., environmental data, is to facilitate determination of reasons that caused a certain electrical current consumption level at the site at a certain period. For example, in February as temperature decreases, the electrical current consumption at the site increases.

In an embodiment, the management server 120 determines for each particular one of a plurality of non-overlapping second periods, an electrical current consumption value that provides a margin above the maximum electrical current consumption of the non-EV load of the site for that particular one of the second periods. Each second period of the plurality of non-overlapping second periods is smaller than the first period. For example, the time series data that has been collected over one month, e.g., during a first time period having a length of one month, indicates that the electrical current consumption of the non-EV load in the site on Sundays between 10:00 to 11:00 is in a range between 3.5 to 4.7 amperes. According to the same example, the management server 120 determines an electrical current consumption value, such as 6 amperes, that provides a prescribed margin above the maximum electrical current consumption of the non-EV load of the site for the time window between 10:00 to 11:00 on Sundays.

In one embodiment, the management server 120 may be configured to determine the electrical current consumption including the margin based on a set of rules. A rule may state, for example, that (a) the electrical current consumption including the margin must be lower than the maximum electrical current that can be provided to the site and (b) the electrical current consumption including the margin must be in a range between 5% to 10% higher than the highest electrical current consumption value of the non-electrical vehicle (EV) load in a specified time period, e.g., an hour, as it is preferable to not change the margin very often. In another embodiment, the amount of the margin or the amount of electrical current consumption including the margin based may be set by the implementer.

In a further embodiment, the management server 120 applies the same electrical current consumption value that includes the margin as long as the electrical current consumption of the non-EV load does not cross a predetermined threshold value. For example, although the electrical current consumption of the non-EV load in the site changes from time to time, as long as the change is below a predetermined threshold, the management server 120 uses the same electrical current consumption value of the non-EV load of the site that includes the margin. Thus, the same electrical current consumption value that includes the margin is maintained.

However, in case the change in the electrical current consumption of the non-EV load in the site is higher than the predetermined threshold, the management server 120 determines a new electrical current consumption value that provides a new, increased, or decreased electrical current consumption value that includes the margin. It should be noted that the management server 120 may be configured to monitor the non-EV electrical current consumption for, effectively, a new first period, which may be a day, week, month, a quarter, etc. which may be the same as or different than the original first period. By monitoring the non-EV electrical current consumption for the first period, a new insight regarding a new and more up to date, and possibly more accurate, electrical current consumption of the non-EV load on the site, may be obtained. For example, the new range of electrical current consumption associated with the non-EV load on Saturdays between 6 am and 2 pm, may be determined to be between 4.5-6.5 amperes, and not 10-12 amperes as it was previously determined. Accordingly, the management server 120 may be configured to determine a new electrical current consumption value for non-EV electrical current consumption of 8 amperes including the margin.

It should be noted that the electrical current consumption value that includes the margin must be lower than or equal to the maximum electrical current supply value that can be provided to a site.

In an embodiment, the management server 120 controls an EV charging system, e.g., at least one EV charger 130, of the site, during each particular third period, to receive electrical current that does not exceed the difference between the maximum electrical current supply value and the electrical current consumption value of the particular second period of the plurality of non-overlapping second periods that is similar to the particular third period in terms of at least length of time and possibly also with respect to a time characteristic of the time periods and also possibly with respect to conditions at the EV site during the time periods. As is well known, similarity of two items may be determined by making a comparison of them and when the result of the comparison is greater than a prescribed threshold the two items compared may be declared similar. For example, a particular third period may be determined to be similar to a particular second period based on at least a factor such as the length of time and also possibly factors such as when the length of time occurs, e.g., time of day, the day of week, the month, and so forth with regard to time characteristics of the time period, as well as a factor of environmental conditions during the time period, e.g., temperature in proximity to the site. In one embodiment when the comparison for each factor is greater than a prescribed threshold for that factor, the periods are declared to be similar. In other embodiments, only a prescribed number of comparisons or combinations of comparisons need exceed their respective prescribed thresholds to be declared similar.

As an illustrative more concrete example, a particular third period may have the following parameters: a length of a day and the day of the week of that day is a Monday, with the date being Jan. 10, 2022 and the temperature at 10 AM is 15 degrees. If the comparison is to a particular second period of a day and the day of the week that particular third day is also a Monday but it is Jul. 15, 2022 and the temperature at 10 AM is 30 degrees, with prescribed thresholds of length of time and day of week as well as with a prescribed threshold of 3 degrees for temperature the system is will determine the periods are not similar due to the failure to meet the prescribed temperature threshold. However, if the comparison is to second period of a day and that day is also a Monday but it is Feb. 15, 2022, the temperature at 10 AM is 13 degrees, with prescribed thresholds of length of time and day of week as well as with a prescribed threshold of 3 degrees for temperature, the system will determine the periods are similar.

As another example, (a) the maximum electrical current supply value that can be provided to a site is 50 ampere, (b) time series data is collected over one month indicates the electrical current consumption of the non-EV load of the site for each day, and (c) the electrical current consumption value that includes the margin above the maximum electrical current consumption of an example second period, e.g., Mondays between 11 PM to 4 AM, is 12 amperes. According to the example, the management server 120 may be configured to allocate 38 amperes to be received by the EV charging system, e.g., the EV chargers 130 of the site, when controlling the EV charging system in real-time, i.e., in a third period, on a Monday between 11 PM to 4 AM. That is, during the third period, i.e., Monday between 11 pm and 4 am, the management server 120 allocates 12 amperes to non-EV load consumption, which reserves a certain amount of electrical current as a reserve for an unexpected power demand by a non-EV load, i.e., the margin, and allocates 38 amperes to be received by an EV charging system, e.g., at least one EV charger 130, of the site. Thus, even if an unexpected power demand occurs by the non-EV load of the site, the margin that was included in the current consumption allocated to the non-EV load for each second period, allows the management server 120 to maintain a stable allocation of electrical current to the EV chargers 130, i.e., without needing to change the amount of electrical current that is allocated to the EV chargers 130 frequently.

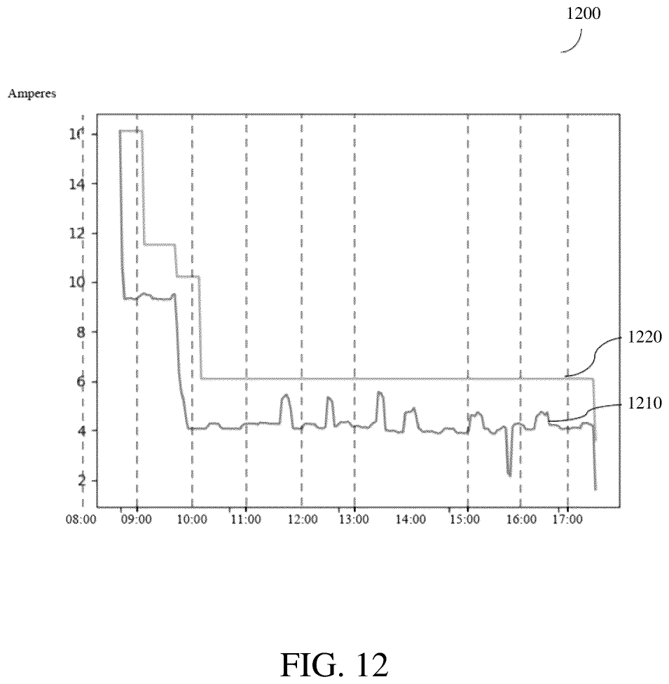

FIG. 12 shows an illustrative diagram 1200 demonstrating the maintenance of electrical load margin for management of electricity supplied to electrical vehicle (EV) charging system, according to an embodiment. The diagram 1200 includes an X-axis and Y-axis. The X-axis represents the time, and the Y-axis represents the number of amperes. The diagram 1200 further includes the lines 1210 and 1220. Line 1210 shows the electrical current consumption of non-EV load in the site in a first period. As noted above with respect to FIG. 11, time series data of electrical current consumption of non-EV load of the site is collected over a first period. Thus, line 1210 depicts the consumed electrical current in the site over a specific first period, e.g., a Monday between 8 am and 5 pm. As noted above with respect to FIG. 11, the first period is divided into a plurality of non-overlapping second periods. The non-overlapping second periods are shown between the broken lines. An electrical current consumption value that provides a margin above the maximum electrical current consumption of each second period is determined for each non-overlapping second period. Line 1220 represents the electrical current consumption value that provides a margin above the maximum electrical current consumption of each second period. Thus, line 1220 is always greater than line 1210 by at least the amount of the margin.

For example, (a) the maximum electrical current supply value that can be provided to a site is 50 ampere, (b) time series data is collected over six months indicates that the electrical current consumption of the non-EV load of the site for each day of the week, and (c) the electrical current consumption value that provides a margin above the maximum non-EV electrical current consumption of an illustrative second period, e.g., Sundays between 2 pm to 3 pm, is 6 amperes. The average actual electrical current consumption on Mondays between 2 pm and 3 pm is represented in FIG. 12 by the portion of line 1210 in that time range. As such, the management server 120 may be configured to allocate 44 amperes for use by the EV charging system, e.g., to be supplied to the EV chargers 130 of the site, when controlling the EV charging system in real-time on a Monday between 2 pm to 3 pm. That is, according to the same example, at the example third period, i.c., Monday between 2 pm and 3 pm, the management server 120 allocates 6 amperes to a non-EV load consumption which includes the margin as a reserve for an unexpected power demand by a non-EV load, and allocating 44 amperes to be received by an EV charging system, e.g., at least one EV charger 130, of the site.

As noted above with respect to FIG. 11, the management server 120 applies the same electrical current consumption value that includes the same margin as long as the electrical current consumption of the non-EV load does not cross a predetermined threshold value. For example, although the electrical current consumption of the non-EV load in the site changes from time to time, as long as the change is below a predetermined threshold, the management server 120 employs the same electrical current consumption value that includes the margin. In other words, the same electrical current consumption value that provides the margin is maintained. However, when the change in the electrical current consumption of the non-EV load in the site is higher than the predetermined threshold, the management server 120 determines a new electrical current consumption value that includes the margin. For example, although the electrical current consumption of the non-EV load between 10 am and 4 pm changes from time to time, as shown by line 1210 at this time frame, the electrical current consumption value that provides the margin remains the same, i.e., 6 amperes.

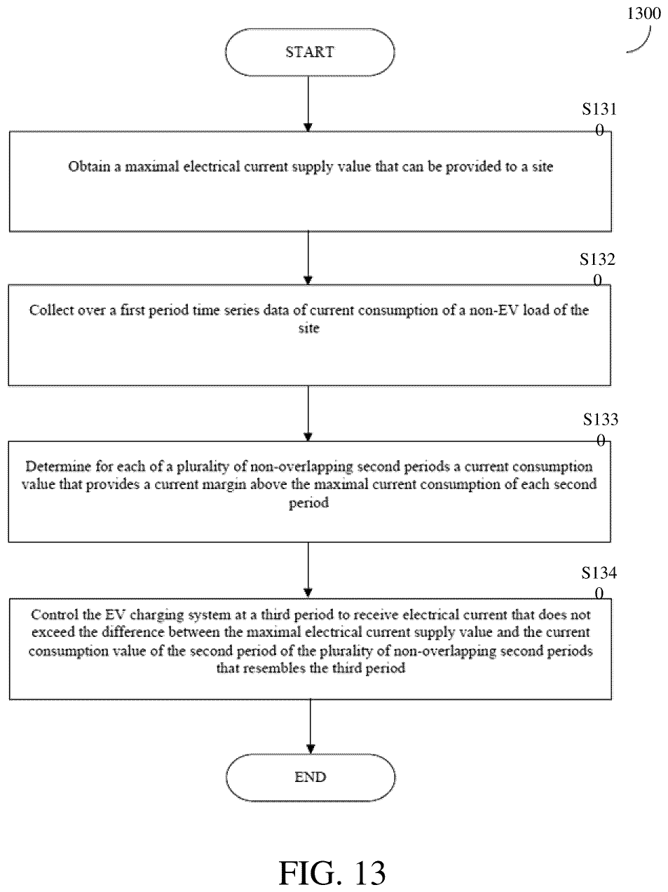

FIG. 13 is a flowchart 1300 of an illustrative method for maintaining an electrical load reserve for management of electricity supply to electrical vehicle (EV) charging system, according to an embodiment. The disclosed method may be executed by the management server 120 of FIG. 11.

At S1310, a maximum electrical current supply value that can be provided to a site is obtained. The maximum electrical current supply value that can be provided to the site may be obtained from a database, e.g., the database 170, a web source, e.g., the web source 180, and the like.

At S1320, time series data of electrical current consumption of a non-EV load of the site is collected over a first period. The time series data of the electrical current consumption of the non-EV load of the site indicates the amount of electrical power that is consumed at the site during a certain time series by electrical devices in use there but excluding the EV chargers, e.g., the EV chargers 130.

At S1330, an electrical current consumption value that provides a margin above the maximum electrical current consumption of each second period of a plurality of second periods, is determined. The electrical current consumption values that includes the margin is determined for each of the plurality of non-overlapping second periods. Each second period is smaller than the first period, e.g., the second periods are subsets of the first period.

At S1340, an EV charging system, e.g., at least one EV charger 130, is controlled during each particular third period to receive electrical current that does not exceed the difference between the maximum electrical current supply value and the electrical current consumption value that includes the margin of the second period of the plurality of non-overlapping second periods that is similar above a predetermined threshold to the particular third period.

It should be noted that collecting the time series data may be performed continuously. That is, even after the EV charging system, e.g., at least one EV charger 130, is already controlled by the management server 120, new time series data may be continuously collected and new electrical current consumption values that provide the requisite margin, are determined. The new time series data and the new electrical current consumption values that provide the margin may affect the way the management server 120 controls the EV charging system.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be implemented as either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

The principles of the disclosure are implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

What is claimed is:

1. A method for charging a plurality of electric vehicles (EVs) at an EV charging site, the method comprising:
collecting, by a management server, a first dataset that is indicative of electric vehicle charging characteristics of each EV user of a plurality of EV users, wherein each EV user of the plurality of EV users is associated with at least one EV of the plurality of EVs;
collecting, by the management server, a second dataset that is indicative of electrical properties of the EV charging site, wherein the EV charging site comprises a plurality of EV chargers connected to an electric infrastructure of the EV charging site, and wherein each EV charger of the plurality of EV chargers is configured to charge a respective EV of the plurality of EVs;
collecting, by the management server, a third dataset that is indicative of electricity prices in a region in which the EV charging site is located;
determining, by the management server, a real-time state of each EV charger of the plurality of EV chargers;
generating an EV charging plan for the EV charging site based on the first dataset, the second dataset, the third dataset, and the real-time state of each EV charger of the plurality of EV chargers;
developing, by the management server and based on the EV charging plan, a schedule for charging each EV charger of the plurality of EV chargers;
causing, by the management server, each EV charger of the plurality of EV chargers to operate according to the schedule;
continuously monitoring in real-time, by the management server, the first dataset, the second dataset, the third dataset, and the real-time state of each EV charger of the plurality of EV chargers; and
updating in real-time, by the management server, the EV charging plan and the schedule based on any changes detected by the management server in the first dataset, the second dataset, the third dataset, and the real-time state of each EV charger of the plurality of EV chargers.

2. The method of claim 1, wherein the second dataset comprises an electrical load capacity of the EV charging site.

3. The method of claim 1, wherein the EV charging plan is generated to fulfill respective charging requirements of each EV user of the plurality of EV users at the EV charging site before the EV user desires to disconnect the EV user's EV from the EV charging site.

4. The method of claim 1, wherein the EV charging plan is generated to charge each EV of the plurality of EVs at a lowest total price for electricity.

5. The method of claim 1, wherein the EV charging plan is generated to prevent a power outage due to overload at the EV charging site.

6. The method of claim 1, wherein updating of the schedule further comprises rescheduling the charging of the at least one of the plurality of EVs based on an updated adjusted EV charging plan.

7. The method of claim 1, wherein generating the EV charging plan further comprises applying in real-time a set of rules to the first dataset, the second dataset, the third dataset, and the real-time state of each EV charger of the plurality of EV chargers.

8. The method of claim 1, wherein generating the EV charging plan further comprises applying in real-time a machine learning model to the first dataset, the second dataset, the third dataset, and the real-time state of each EV charger of the plurality of EV chargers.

9. The method of claim 1, further comprising:
receiving EV information associated with each EV user of the plurality of EVs.

10. The method of claim 1, wherein the real-time state of each EV charger of the plurality of EV chargers comprises an activation status.

11. An apparatus comprising:
a processing circuitry; and
memory, the memory comprising instructions that, when executed by the processing circuitry, cause the apparatus to:
collect a first dataset that is indicative of electric vehicle charging characteristics of each EV user of a plurality of EV users, wherein each EV user is associated with at least one EV of a plurality of EVs at an EV charging site;
collect a second dataset that is indicative of electrical properties of the EV charging site, wherein the EV charging site comprises a plurality of EV chargers connected to an electric infrastructure of the EV charging site, and wherein each EV charger of the plurality of EV chargers is configured to charge a respective EV of the plurality of EVs;
collect a third dataset that is indicative of electricity prices in a region in which the EV charging site is located;
determine a real-time state of each EV charger of the plurality of EV chargers;
generate an EV charging plan for the EV charging site based on the first dataset, the second dataset, the third dataset, and the real-time state of each EV charger of the plurality of EV chargers; and
develop, based on the EV charging plan, a schedule for charging operation of each EV charger of the plurality of EV chargers;
cause each EV charger of the plurality of EV chargers to operate according to the schedule;
continuously monitor in real-time the first dataset, the second dataset, the third dataset, and the real-time state of each EV charger of the plurality of EV chargers; and
update in in real-time the EV charging plan and schedule based on any changes detected by the apparatus in the first dataset, the second dataset, the third dataset, and
the real-time state of each of the EV chargers.

12. The apparatus of claim 11, wherein the second dataset comprises an electrical load capacity of the EV charging site.

13. The apparatus of claim 11, wherein the EV charging plan fulfills respective charging requirements of each EV user of the plurality of EV users at the EV charging site before the EV user desires to disconnect the EV user's EV from the EV charging site.

14. The apparatus of claim 11, wherein the EV charging plan is such as to charge each EV of the plurality of EVs at a lowest total price for electricity.

15. The apparatus of claim 11, wherein the generated EV charging plan is adapted to prevent a power outage due to overload at the EV charging site.

16. The apparatus of claim 11, wherein the instructions, when executed by the processing circuitry, cause the apparatus to update the schedule by rescheduling charging of the at least one EV of the plurality of EVs based on an updated adjusted EV charging plan.

17. The apparatus of claim 11, wherein the instructions, when executed by the processing circuitry, cause the apparatus to generate the EV charging plan by applying in real-time a set of rules to the first dataset, the second dataset, the third dataset, and the real-time state of each EV charger of the plurality of EV chargers.

18. The apparatus of claim 11, wherein the instructions, when executed by the processing circuitry, cause the apparatus to: generate the EV charging plan by applying in real-time a machine learning model to the first dataset, the second dataset, the third dataset, and the real-time state of each EV charger of the plurality of EV chargers.

19. The apparatus of claim 11, wherein the instructions, when executed by the processing circuitry, cause the apparatus to:
receive EV information associated with each EV of the plurality of EVs.

20. The apparatus of claim 11, wherein the real-time state of cach EV charger comprises an activation status.
